(19) United States
(12) Patent Application Publication
(10) Pub. No.: US 2019/0239509 A1
(43) Pub. Date: Aug. 8, 2019

(54) METHOD OF CONTROLLING PLANTS

(71) Applicant: SYNGENTA PARTICIPATIONS AG, Basel (CH)

(72) Inventors: Akos BALOGH, Basel (CH); Brian PICKETT, Berkshire (GB); Nikolaos KALOUMENOS, Berkshire (GB); Eric Walker PALMER, Greensboro, NC (US)

(73) Assignee: SYNGENTA PARTICIPATIONS AG, Basel (CH)

(21) Appl. No.: 16/319,302

(22) PCT Filed: Jul. 20, 2017
(86) PCT No.: PCT/EP2017/068314

§ 371 Date: Jan. 18, 2019

(30) Foreign Application Priority Data
Jul. 22, 2016 (GB) 1612748.2

(51) Int. Cl. A01N 43/58; A01N 43/80; A01N 43/50; A01N 43/56

(52) U.S. Cl. CPC A01N 43/58; A01N 43/80; A01N 43/40; A01N 43/56; A01N 43/50

(57) ABSTRACT

The present invention provides a method of controlling plants comprising applying to the plants, or to the locus of the plants a composition comprising (A) a compound of formula (I) selected from the group consisting of: Formula (I), or an N-oxide or salt form thereof, and (B) one or more further herbicides.

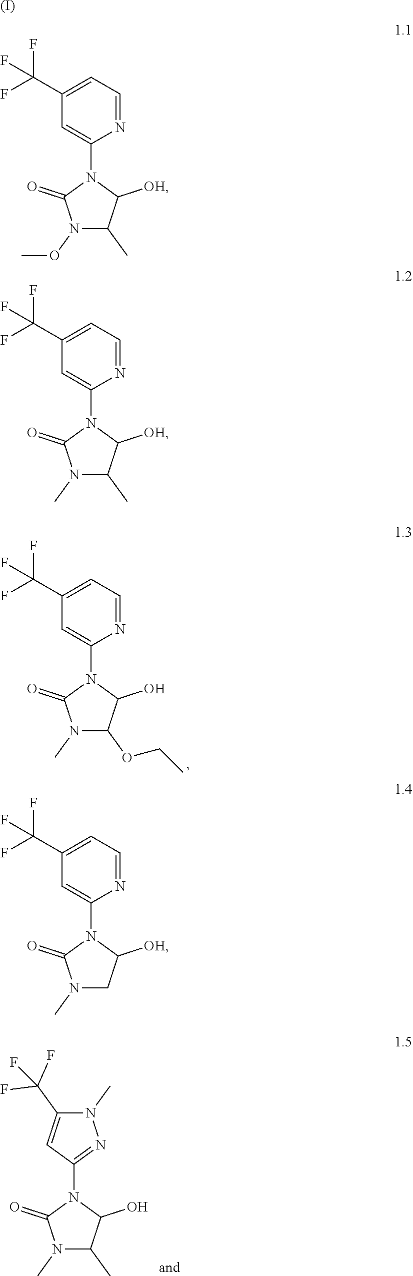

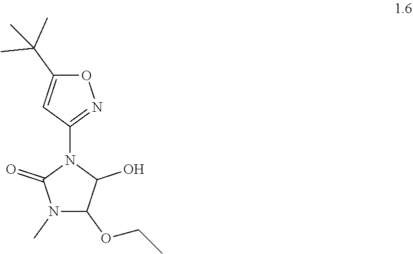 [SMILES: CCOC1C(O)N(c2cc(C(C)(C)C)on2)C(=O)N1C]

The present invention relates to method of controlling plants and/or inhibiting plant growth using low rate herbicidal compositions.

Herbicidal dihydro-hydantoins of the formula

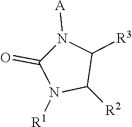

wherein A is a pyridine ring are taught in U.S. Pat. No. 4,600,430, WO 2015/059262 and WO 2015/052076. Further hydantoins wherein A is an isoxazole ring are taught in e.g. U.S. Pat. No. 4,302,239, Canadian Patent No. 1205077 and WO 2015/193202 and where A is a pyrazole ring in WO 2015/097043.

The object of the present invention is to provide a method of controlling plants using low rate herbicidal mixtures which are highly effective against various weed species and/or have increased crop tolerance.

### SUMMARY OF THE INVENTION

In one aspect, therefore, the present invention provides a method of controlling plants, comprising applying to the plants, or to the locus of the plants, a composition comprising (A) a compound of formula (I) selected from the group consisting of

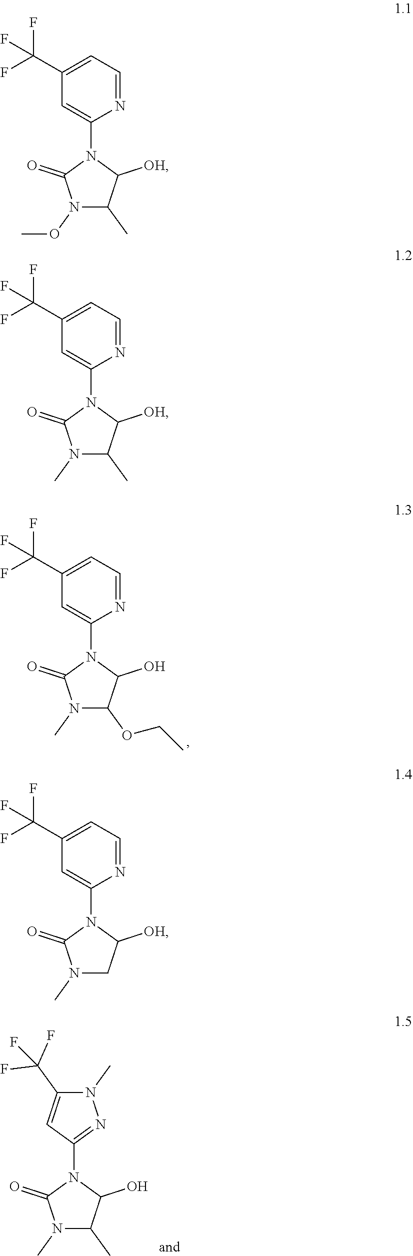

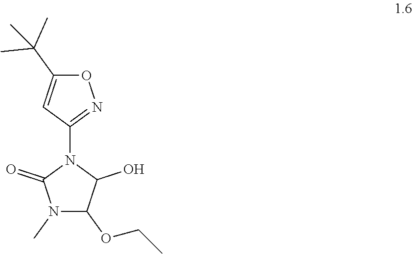 [SMILES: CCOC1C(O)N(c2cc(C(C)(C)C)on2)C(=O)N1C]

or an N-oxide or salt form thereof,
and (B) bicyclopyrone, fenquinotrione, isoxaflutole, mesotrione, pyrasulfotole, sulcotrione, tembotrione, tolpyralate, topramezone, or a compound of formula (II):

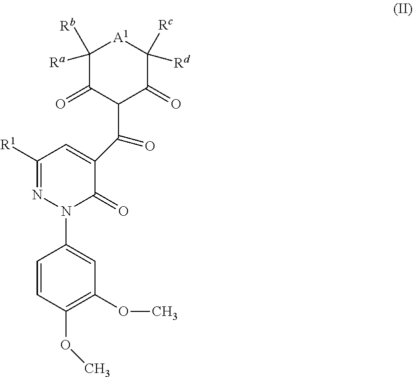

or a salt thereof,
wherein
R¹ is selected from the group consisting of hydrogen, halogen, cyano, nitro, C₁-C₆alkyl-, C₃-C₆cycloalkyl-, C₂-C₆-alkenyl-, C₂-C₆alkynyl-, C₁-C₆haloalkyl-, C₁-C₆alkoxy-, C₁-C₃haloalkoxy-, C₁-C₆alkoxy-C₁-C₃alkyl-, C₁-C₆alkyl-S(O)p- and C₁-C₆haloalkyl-S(O)p-;
A¹ is selected from the group consisting of O, C(O) and (CR^{e}R^{f});

R^{a}, R^{b}, R^{c}, R^{d}, R^{e} and R^{f} are each independently selected from the group consisting of hydrogen and C₁-C₄alkyl wherein R^{a} and R^{c} may together form a C₁-C₃alkylene chain; and
p is 0, 1 or 2,
and wherein (A) is applied at a rate of between 25 and 200 g a.i./ha and (B) is applied at a rate of between 25 and 150 g a.i./ha.

In a second aspect, the invention provides a method of inhibiting plant growth, comprising applying to the plants or to the locus thereof, a composition as defined above.

In a third aspect, the invention provides a method of controlling weeds in crops of useful plants, comprising applying to the weeds or to the locus of the weeds, or to the useful plants or to the locus of the useful plants, a composition as defined above.

In a fourth aspect, the invention provides a method of selectively controlling grasses and/or weeds in crops of useful plants which comprises applying to the useful plants or locus thereof or to the area of cultivation a composition as defined above.

### DETAILED DESCRIPTION

Surprisingly, it has been found that when (A), a compound of formula (I), is mixed with a herbicide (B), the components (A) and (B) can be applied at a much lower rate than expected whilst maintaining good control of the weed population. In addition, this weed control occurs whilst also maintaining very good crop safety. As such, the compositions of the invention may be applied pre-emergence or post-emergence of the crop, but may particularly be applied post-emergence.

Particularly preferred embodiments of the invention are as set out below.

In one embodiment, (A) is compound 1.1.

In one embodiment (A) is compound 1.2.

In one embodiment (A) is compound 1.3.

In one embodiment (A) is compound 1.4.

In one embodiment (A) is compound 1.5.

In one embodiment (A) is compound 1.6.

Preferably, (B) is bicyclopyrone, isoxaflutole, mesotrione or a compound of formula (II).

In one embodiment, (B) is mesotrione.

In another embodiment, (B) is a compound of formula (II).

When (B) is a compound of formula (II), the following embodiments are preferred:

In one embodiment, (B) is a compound of formula (II) and R¹ is C₁-C₆ alkyl (preferably methyl) or C₃-C₆cycloalkyl (preferably cyclopropyl). In a more preferred embodiment R¹ is methyl or cyclopropyl.

In one embodiment, (B) is a compound of formula (II) and A¹ is CR^{e}R^{f} and R^{e} and R^{f} are hydrogen.

In one embodiment, (B) is a compound of formula (II) and A¹ is CR^{e}R^{f} and R^{a}, R^{b}, R^{c}, R^{d}, R^{e} and R^{f} are hydrogen.

In one embodiment, (B) is a compound of formula (II) and A¹ is CR^{e}R^{f}; R^{a}, R^{b}, R^{c}, R^{d}, and R^{e} are hydrogen and R^{f} is methyl.

In one embodiment, (B) is a compound of formula (II) and A¹ is CR^{e}R^{f}; R^{a}, R^{b}, R^{c}, R^{d} are hydrogen and R^{e} and R^{f} are methyl.

In one embodiment (B), is a compound of formula (II) and A¹ is CR^{e}R^{f}; R^{b}, R^{c}, R^{e} and R^{f} are hydrogen, and R^{a} and R^{c} together form an ethylene (—CH₂—CH₂—) chain.

In one embodiment, (B) is a compound of formula (II) and A¹ is C═O and R^{a}, R^{b}, R^{c} and R^{d} are methyl.

In one embodiment, (B) is a compound of formula (II) and A¹ is O and R^{a}, R^{b}, R^{c} and R^{d} are methyl.

More preferably the compound of formula (II) is selected from the compounds in Table 1 below:

TABLE 1

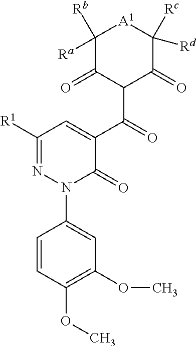

| Compound | A¹ | R^{a} | R^{c} | R^{b} | R^{d} | R¹ |
|---|---|---|---|---|---|---|
| 2.1 | CH₂ | —CH₂—CH₂— | | H | H | CH₃ |
| 2.2 | CHCH₃ | H | H | H | H | CH₃ |
| 2.3 | CH₂ | H | H | H | H | CH₃ |
| 2.4 | C(CH₃)₂ | H | H | H | H | CH₃ |
| 2.5 | C═O | CH₃ | CH₃ | CH₃ | CH₃ | CH₃ |
| 2.6 | CHC₂H₅ | H | H | H | H | CH₃ |
| 2.7 | CH₂ | CH₃ | CH₃ | CH₃ | CH₃ | CH₃ |
| 2.8 | CHCH₃ | H | H | H | H | cPr |
| 2.9 | CH₂ | —CH₂—CH₂— | | H | H | cPr |
| 2.10 | C(CH₃)₂ | H | H | H | H | cPr |
| 2.11 | C═O | CH₃ | CH₃ | CH₃ | CH₃ | cPr |
| 2.12 | CH₂ | H | H | H | H | cPr |
| 2.13 | O | CH₃ | CH₃ | CH₃ | CH₃ | CH₃ |
| 2.14 | O | CH₃ | CH₃ | CH₃ | CH₃ | cPr |

C₁-C₆alkyl- and C₁-C₄alkyl- includes, for example, methyl (Me, CH₃), ethyl (Et, C₂H₅), n-propyl (n-Pr), isopropyl (i-Pr), n-butyl (n-Bu), isobutyl (i-Bu), sec-butyl and tert-butyl (t-Bu).

C₂-C₆-alkenyl- includes, for example, —CH═CH₂ (vinyl) and —CH₂—CH═CH₂ (allyl).

C₂-C₆alkynyl- includes, for example, —C≡CH (ethynyl) and —CH₂—C≡CH (propargyl).

Halogen (or halo) includes, for example, fluorine, chlorine, bromine or iodine. The same correspondingly applies to halogen in the context of other definitions, such as haloalkyl.

C₁-C₆haloalkyl- includes, for example, fluoromethyl, difluoromethyl, trifluoromethyl, chloromethyl, dichloromethyl, trichloromethyl, 2,2,2-trifluoroethyl, 2-fluoroethyl, 2-chloroethyl, pentafluoroethyl, 1,1-difluoro-2,2,2-trichloroethyl, 2,2,3,3-tetrafluoropropyl and 2,2,2-trichloroethyl, heptafluoro-n-propyl and perfluoro-n-hexyl.

C₁-C₆alkoxy- includes, for example, methoxy, ethoxy, propoxy, isopropoxy, n-butoxy, isobutoxy, sec-butoxy or tert-butoxy or a pentyloxy or hexyloxy isomer, preferably methoxy and ethoxy. Two alkoxy substituents present on the same carbon atom may be joined to form a cyclic group. Thus, the methyl groups present in two methoxy substituents may be joined to form a 1,3 dioxolane substituent, for example.

C₁-C₃haloalkoxy- includes, for example, fluoromethoxy, difluoromethoxy, trifluoromethoxy, 2,2,2-trifluoroethoxy, 1,1,2,2-tetrafluoroethoxy, 2-fluoroethoxy, 2-chloroethoxy, 2,2-difluoroethoxy or 2,2,2-trichloroethoxy, preferably difluoromethoxy, 2-chloroethoxy or trifluoromethoxy.

C₁-C₆alkyl-S— (alkylthio) includes, for example, methylthio, ethylthio, propylthio, isopropylthio, n-butylthio, isobutylthio, sec-butylthio or tert-butylthio, preferably methylthio or ethylthio. C₁-C₆haloalkyl-S— (haloalkylthio) relates to halogenated derivatives thereof.

C₁-C₆alkyl-S(O)— (alkylsulfinyl) includes, for example, methylsulfinyl, ethylsulfinyl, propylsulfinyl, isopropylsulfinyl, n-butylsulfinyl, isobutylsulfinyl, sec-butylsulfinyl or tert-butylsulfinyl, preferably methylsulfinyl or ethylsulfinyl. C₁-C₆haloalkyl-S(O)— (haloalkylsulfinyl) relates to halogenated derivatives thereof.

C₁-C₆alkyl-S(O)₂— (alkylsulfonyl) includes, for example, methylsulfonyl, ethylsulfonyl, propylsulfonyl, isopropylsulfonyl, n-butylsulfonyl, isobutylsulfonyl, sec-butylsulfonyl or tert-butylsulfonyl, preferably methylsulfonyl or ethylsulfonyl. C₁-C₆haloalkyl-S(O)₂— (haloalkylsulfonyl) relates to halogenated derivatives thereof.

C₁-C₆alkoxy-C₁-C₃alkyl- includes, for example, methoxymethyl, methoxyethyl, ethoxymethyl, ethoxyethyl, n-propoxymethyl, n-propoxyethyl, isopropoxymethyl or isopropoxyethyl.

C₁-C₆haloalkoxy-C₁-C₃alkyl- includes, for example, 2,2,2-trifluoroethoxymethyl-.

C₃-C₆cycloalkyl- includes, for example, cyclopropyl (c-propyl (c-Pr)), cyclobutyl (c-butyl (c-Bu)), cyclopentyl (c-pentyl) and cyclohexyl (c-hexyl).

Preferably, (A) is applied at a rate of 50 to 150 g a.i./ha. In particular, (A) may be applied at 25, 50, 75, 100, 125, 150, 175 or 200 g a.i/ha

Preferably (B) is applied at a rate of 50 to 125 g a.i./ha. More preferably, (B) is applied at a rate of 75 to 125 g a.i./ha. In particular, (B) may be applied at 50, 75, 100, 125 or 150 g a.i/ha.

Whilst two-way mixtures of (A) and (B) are explicitly disclosed above, the skilled man will appreciate that the invention extends to three-way and further multiple combinations comprising the above two-way mixtures as well as other herbicides. In particular, the present invention provides methods utilising compositions comprising the three-way mixtures listed in Table 2 below:

TABLE 2

| (A) Compound | | |
|---|---|---|
| of formula | | |
| (I) | (B) Mixing Partner 1 | Mixing Partner 2 |
| 1.1 | Mesotrione | Bicyclopyrone |
| 1.1 | Mesotrione | Atrazine |
| 1.1 | Mesotrione | S-metolachlor |
| 1.1 | Mesotrione | Terbuthylazine |
| 1.1 | Mesotrione | Dimethachlor |
| 1.1 | Mesotrione | Flufenacet |
| 1.1 | Mesotrione | Glyphosate |
| 1.1 | Mesotrione | Isoxaflutole |
| 1.1 | Mesotrione | Nicosulfuron |
| 1.1 | Mesotrione | Ametryn |
| 1.1 | Mesotrione | Hexazinone |
| 1.1 | Mesotrione | Paraquat |
| 1.1 | Mesotrione | Diquat |
| 1.1 | Mesotrione | Pyridate |
| 1.1 | Mesotrione | Acetochlor |
| 1.1 | Mesotrione | Dimethenamid-P |
| 1.1 | Mesotrione | Pendimethalin |
| 1.1 | Mesotrione | Alachlor |
| 1.1 | Mesotrione | Pethoxamid |
| 1.1 | Mesotrione | Pyroxasulfone |
| 1.1 | Mesotrione | Trifloxysulfuron-sodium |
| 1.1 | Mesotrione | Flazasulfuron |
| 1.1 | Mesotrione | Prosulfocarb |
| 1.1 | Mesotrione | Metolachlor |
| 1.1 | Mesotrione | 2.1 |
| 1.1 | Mesotrione | 2.2 |
| 1.1 | Mesotrione | 2.3 |
| 1.1 | Mesotrione | 2.4 |
| 1.1 | Mesotrione | 2.5 |
| 1.1 | Mesotrione | 2.9 |
| 1.1 | Mesotrione | 2.11 |
| 1.1 | Bicyclopyrone | Atrazine |
| 1.1 | Bicyclopyrone | S-metolachlor |
| 1.1 | Bicyclopyrone | Terbuthylazine |
| 1.1 | Bicyclopyrone | Dimethachlor |
| 1.1 | Bicyclopyrone | Flufenacet |
| 1.1 | Bicyclopyrone | Glyphosate |
| 1.1 | Bicyclopyrone | Isoxaflutole |
| 1.1 | Bicyclopyrone | Nicosulfuron |
| 1.1 | Bicyclopyrone | Ametryn |
| 1.1 | Bicyclopyrone | Hexazinone |
| 1.1 | Bicyclopyrone | Paraquat |
| 1.1 | Bicyclopyrone | Diquat |
| 1.1 | Bicyclopyrone | Pyridate |
| 1.1 | Bicyclopyrone | Acetochlor |
| 1.1 | Bicyclopyrone | Dimethenamid-P |
| 1.1 | Bicyclopyrone | Pendimethalin |
| 1.1 | Bicyclopyrone | Alachlor |
| 1.1 | Bicyclopyrone | Pethoxamid |
| 1.1 | Bicyclopyrone | Pyroxasulfone |
| 1.1 | Bicyclopyrone | Trifloxysulfuron-sodium |
| 1.1 | Bicyclopyrone | Flazasulfuron |
| 1.1 | Bicyclopyrone | Prosulfocarb |
| 1.1 | Bicyclopyrone | Metolachlor |
| 1.1 | Bicyclopyrone | 2.1 |
| 1.1 | Bicyclopyrone | 2.2 |
| 1.1 | Bicyclopyrone | 2.3 |
| 1.1 | Bicyclopyrone | 2.4 |
| 1.1 | Bicyclopyrone | 2.5 |
| 1.1 | Bicyclopyrone | 2.9 |
| 1.1 | Bicyclopyrone | 2.11 |
| 1.1 | Isoxaflutole | Nicosulfuron |
| 1.1 | Isoxaflutole | Ametryn |
| 1.1 | Isoxaflutole | Hexazinone |
| 1.1 | Isoxaflutole | Paraquat |
| 1.1 | Isoxaflutole | Diquat |
| 1.1 | Isoxaflutole | Pyridate |
| 1.1 | Isoxaflutole | Acetochlor |
| 1.1 | Isoxaflutole | Dimethenamid-P |
| 1.1 | Isoxaflutole | Pendimethalin |
| 1.1 | Isoxaflutole | Alachlor |
| 1.1 | Isoxaflutole | Pethoxamid |
| 1.1 | Isoxaflutole | Pyroxasulfone |
| 1.1 | Isoxaflutole | Trifloxysulfuron-sodium |
| 1.1 | Isoxaflutole | Flazasulfuron |
| 1.1 | Isoxaflutole | Prosulfocarb |
| 1.1 | Isoxaflutole | Metolachlor |
| 1.1 | Isoxaflutole | 2.1 |
| 1.1 | Isoxaflutole | 2.2 |
| 1.1 | Isoxaflutole | 2.3 |
| 1.1 | Isoxaflutole | 2.4 |
| 1.1 | Isoxaflutole | 2.5 |
| 1.1 | Isoxaflutole | 2.9 |
| 1.1 | Isoxaflutole | 2.11 |
| 1.1 | 2.1 | Atrazine |
| 1.1 | 2.1 | S-metolachlor |
| 1.1 | 2.1 | Terbuthylazine |
| 1.1 | 2.1 | Dimethachlor |
| 1.1 | 2.1 | Flufenacet |
| 1.1 | 2.1 | Glyphosate |
| 1.1 | 2.1 | Nicosulfuron |
| 1.1 | 2.1 | Ametryn |
| 1.1 | 2.1 | Hexazinone |
| 1.1 | 2.1 | Paraquat |
| 1.1 | 2.1 | Diquat |
| 1.1 | 2.1 | Pyridate |
| 1.1 | 2.1 | Acetochlor |
| 1.1 | 2.1 | Dimethenamid-P |
| 1.1 | 2.1 | Pendimethalin |
| 1.1 | 2.1 | Alachlor |
| 1.1 | 2.1 | Pethoxamid |
| 1.1 | 2.1 | Pyroxasulfone |
| 1.1 | 2.1 | Trifloxysulfuron-sodium |
| 1.1 | 2.1 | Flazasulfuron |
| 1.1 | 2.1 | Prosulfocarb |
| 1.1 | 2.1 | Metolachlor |
| 1.1 | 2.2 | Atrazine |
| 1.1 | 2.2 | S-metolachlor |
| 1.1 | 2.2 | Terbuthylazine |
| 1.1 | 2.2 | Dimethachlor |
| 1.1 | 2.2 | Flufenacet |
| 1.1 | 2.2 | Glyphosate |
| 1.1 | 2.2 | Nicosulfuron |
| 1.1 | 2.2 | Ametryn |
| 1.1 | 2.2 | Hexazinone |
| 1.1 | 2.2 | Paraquat |
| 1.1 | 2.2 | Diquat |
| 1.1 | 2.2 | Pyridate |
| 1.1 | 2.2 | Acetochlor |
| 1.1 | 2.2 | Dimethenamid-P |
| 1.1 | 2.2 | Pendimethalin |
| 1.1 | 2.2 | Alachlor |
| 1.1 | 2.2 | Pethoxamid |
| 1.1 | 2.2 | Pyroxasulfone |
| 1.1 | 2.2 | Trifloxysulfuron-sodium |
| 1.1 | 2.2 | Flazasulfuron |
| 1.1 | 2.2 | Prosulfocarb |
| 1.1 | 2.2 | Metolachlor |
| 1.1 | 2.3 | Atrazine |
| 1.1 | 2.3 | S-metolachlor |
| 1.1 | 2.3 | Terbuthylazine |
| 1.1 | 2.3 | Dimethachlor |
| 1.1 | 2.3 | Flufenacet |
| 1.1 | 2.3 | Glyphosate |
| 1.1 | 2.3 | Nicosulfuron |
| 1.1 | 2.3 | Ametryn |
| 1.1 | 2.3 | Hexazinone |
| 1.1 | 2.3 | Paraquat |
| 1.1 | 2.3 | Diquat |
| 1.1 | 2.3 | Pyridate |
| 1.1 | 2.3 | Acetochlor |
| 1.1 | 2.3 | Dimethenamid-P |
| 1.1 | 2.3 | Pendimethalin |
| 1.1 | 2.3 | Alachlor |
| 1.1 | 2.3 | Pethoxamid |
| 1.1 | 2.3 | Pyroxasulfone |
| 1.1 | 2.3 | Trifloxysulfuron-sodium |
| 1.1 | 2.3 | Flazasulfuron |
| 1.1 | 2.3 | Prosulfocarb |
| 1.1 | 2.3 | Metolachlor |
| 1.1 | 2.4 | Atrazine |
| 1.1 | 2.4 | S-metolachlor |
| 1.1 | 2.4 | Terbuthylazine |
| 1.1 | 2.4 | Dimethachlor |
| 1.1 | 2.4 | Flufenacet |
| 1.1 | 2.4 | Glyphosate |
| 1.1 | 2.4 | Nicosulfuron |
| 1.1 | 2.4 | Ametryn |
| 1.1 | 2.4 | Hexazinone |
| 1.1 | 2.4 | Paraquat |
| 1.1 | 2.4 | Diquat |
| 1.1 | 2.4 | Pyridate |
| 1.1 | 2.4 | Acetochlor |
| 1.1 | 2.4 | Dimethenamid-P |
| 1.1 | 2.4 | Pendimethalin |
| 1.1 | 2.4 | Alachlor |
| 1.1 | 2.4 | Pethoxamid |
| 1.1 | 2.4 | Pyroxasulfone |
| 1.1 | 2.4 | Trifloxysulfuron-sodium |
| 1.1 | 2.4 | Flazasulfuron |
| 1.1 | 2.4 | Prosulfocarb |
| 1.1 | 2.4 | Metolachlor |
| 1.1 | 2.5 | Atrazine |
| 1.1 | 2.5 | S-metolachlor |
| 1.1 | 2.5 | Terbuthylazine |
| 1.1 | 2.5 | Dimethachlor |
| 1.1 | 2.5 | Flufenacet |
| 1.1 | 2.5 | Glyphosate |
| 1.1 | 2.5 | Nicosulfuron |
| 1.1 | 2.5 | Ametryn |
| 1.1 | 2.5 | Hexazinone |
| 1.1 | 2.5 | Paraquat |
| 1.1 | 2.5 | Diquat |
| 1.1 | 2.5 | Pyridate |
| 1.1 | 2.5 | Acetochlor |
| 1.1 | 2.5 | Dimethenamid-P |
| 1.1 | 2.5 | Pendimethalin |
| 1.1 | 2.5 | Alachlor |
| 1.1 | 2.5 | Pethoxamid |
| 1.1 | 2.5 | Pyroxasulfone |
| 1.1 | 2.5 | Trifloxysulfuron-sodium |
| 1.1 | 2.5 | Flazasulfuron |
| 1.1 | 2.5 | Prosulfocarb |
| 1.1 | 2.5 | Metolachlor |
| 1.1 | 2.9 | Atrazine |
| 1.1 | 2.9 | S-metolachlor |
| 1.1 | 2.9 | Terbuthylazine |
| 1.1 | 2.9 | Dimethachlor |
| 1.1 | 2.9 | Flufenacet |
| 1.1 | 2.9 | Glyphosate |
| 1.1 | 2.9 | Nicosulfuron |
| 1.1 | 2.9 | Ametryn |
| 1.1 | 2.9 | Hexazinone |
| 1.1 | 2.9 | Paraquat |
| 1.1 | 2.9 | Diquat |
| 1.1 | 2.9 | Pyridate |
| 1.1 | 2.9 | Acetochlor |
| 1.1 | 2.9 | Dimethenamid-P |
| 1.1 | 2.9 | Pendimethalin |
| 1.1 | 2.9 | Alachlor |
| 1.1 | 2.9 | Pethoxamid |
| 1.1 | 2.9 | Pyroxasulfone |
| 1.1 | 2.9 | Trifloxysulfuron-sodium |
| 1.1 | 2.9 | Flazasulfuron |
| 1.1 | 2.9 | Prosulfocarb |
| 1.1 | 2.9 | Metolachlor |
| 1.1 | 2.11 | Atrazine |
| 1.1 | 2.11 | S-metolachlor |
| 1.1 | 2.11 | Terbuthylazine |
| 1.1 | 2.11 | Dimethachlor |
| 1.1 | 2.11 | Flufenacet |
| 1.1 | 2.11 | Glyphosate |
| 1.1 | 2.11 | Nicosulfuron |
| 1.1 | 2.11 | Ametryn |
| 1.1 | 2.11 | Hexazinone |
| 1.1 | 2.11 | Paraquat |
| 1.1 | 2.11 | Diquat |
| 1.1 | 2.11 | Pyridate |
| 1.1 | 2.11 | Acetochlor |
| 1.1 | 2.11 | Dimethenamid-P |
| 1.1 | 2.11 | Pendimethalin |
| 1.1 | 2.11 | Alachlor |
| 1.1 | 2.11 | Pethoxamid |
| 1.1 | 2.11 | Pyroxasulfone |
| 1.1 | 2.11 | Trifloxysulfuron-sodium |
| 1.1 | 2.11 | Flazasulfuron |
| 1.1 | 2.11 | Prosulfocarb |
| 1.1 | 2.11 | Metolachlor |

Furthermore, the present invention also provides compositions comprising the three-way mixtures listed in Table 1 above, wherein the compound 1.1 is replaced with compound 1.2.

Furthermore, the present invention also provides compositions comprising the three-way mixtures listed in Table 1 above, wherein the compound 1.1 is replaced with compound 1.3.

Furthermore, the present invention also provides compositions comprising the three-way mixtures listed in Table 1 above, wherein the compound 1.1 is replaced with compound 1.4.

Furthermore, the present invention also provides compositions comprising the three-way mixtures listed in Table 1 above, wherein the compound 1.1 is replaced with compound 1.5.

Furthermore, the present invention also provides compositions comprising the three-way mixtures listed in Table 1 above, wherein the compound 1.1 is replaced with compound 1.6.

Whilst generally considered crop-safe at the rates used in this invention, the compositions can further include one or more safeners. In particular, the following safeners are particularly preferred: AD 67 (MON 4660), benoxacor, cloquintocet-mexyl, cyometrinil, cyprosulfamide, dichlormid, dicyclonon, dietholate, fenchlorazole-ethyl, fenclorim, flurazole, fluxofenim, furilazole, furilazome, isoxadifen-ethyl, mefenpyr-diethyl, mephenate, oxabetrinil, naphthalic anhydride (CAS RN 81-84-5), TI-35, N-isopropyl-4-(2-methoxy-benzoylsulfamoyl)-benzamide (CAS RN 221668-34-4) and N-(2-methoxybenzoyl)-4-[(methylaminocarbonyl)amino]benzenesulfonamide.

Particularly preferred safeners are cloquintocet-mexyl, cyprosulfamide, isoxadifen-ethyl, mefenpyr-diethyl and N-(2-methoxybenzoyl)-4-[(methylaminocarbonyl)amino]benzenesulfonamide.

Safeners can also be used in the three-way compositions detailed above and, in addition, in further multiple combinations comprising the two-way mixtures.

The compounds of formula (I) may exist as different geometric isomers, or in different tautomeric forms. This invention covers all such isomers and tautomers, and mixtures thereof in all proportions, as well as isotopic forms such as deuterated compounds. They may contain one or more asymmetric centers and may thus give rise to optical isomers and diastereomers. While shown without respect to stereochemistry, the present invention includes all such optical isomers and diastereomers as well as the racemic and resolved, enantiomerically pure R and S stereoisomers and other mixtures of the R and S stereoisomers and agrochemically acceptable salts thereof. It is recognized certain optical isomers or diastereomers may have favorable properties over the other. Thus when disclosing and claiming the invention, when a racemic mixture is disclosed, it is clearly contemplated that both optical isomers, including diastereomers, substantially free of the other, are disclosed and claimed as well.

In particular, the present invention covers the following forms of compounds 1.1 to 1.6:

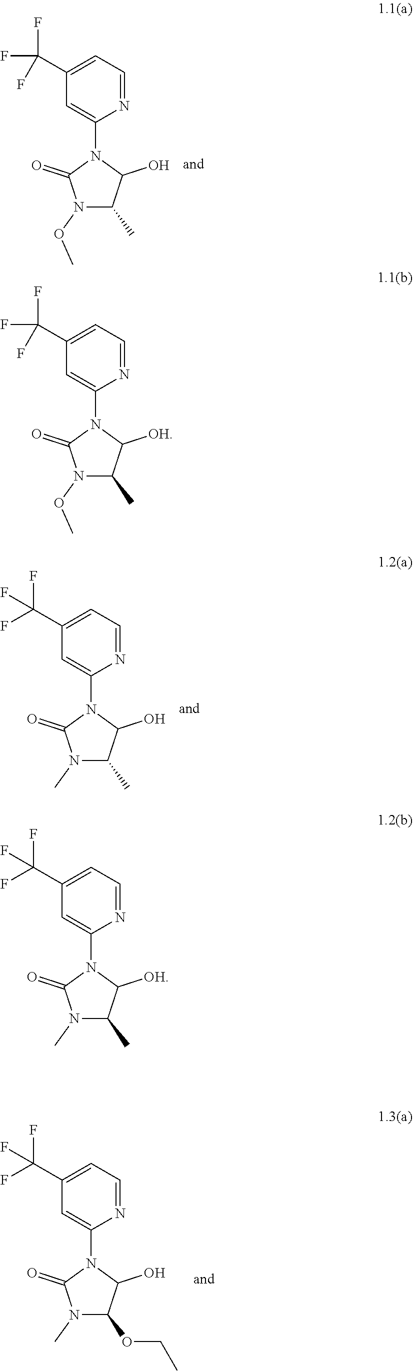

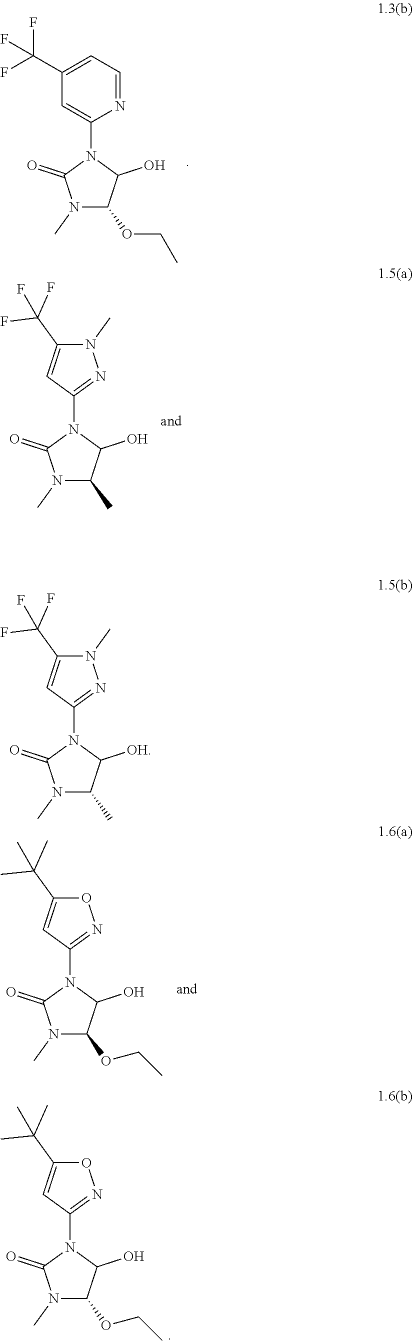

Suitable salts of compounds 1.1 to 1.6 include those derived from alkali or alkaline earth metals and those derived from ammonia and amines. Preferred cations include sodium, potassium, magnesium, and ammonium cations of the formula N⁺(R¹⁹R²⁰R²¹R²²) wherein R¹⁹, R²⁰, R²¹ and R²² are independently selected from hydrogen, C₁-C₆ alkyl and C₁-C₆ hydroxyalkyl. Salts of the compounds of formula (I) can be prepared by treatment of compounds of formula (I) with a metal hydroxide, such as sodium hydroxide, or an amine, such as ammonia, trimethylamine, diethanolamine, 2-methylthiopropylamine, bisallylamine, 2-butoxyethylamine, morpholine, cyclododecylamine, or benzylamine. Amine salts are often preferred forms of the compounds of formula (I) because they are water-soluble and lend themselves to the preparation of desirable aqueous based herbicidal compositions.

Acceptable salts can be formed from organic and inorganic acids, for example, acetic, propionic, lactic, citric, tartaric, succinic, fumaric, maleic, malonic, mandelic, malic, phthalic, hydrochloric, hydrobromic, phosphoric, nitric, sulfuric, methanesulfonic, naphthalenesulfonic, benzenesulfonic, toluenesulfonic, camphorsulfonic, and similarly known acceptable acids when a compound of this invention contains a basic moiety.

Compounds of formula (II) may also contain asymmetric centres and may be present as a single enantiomer, pairs of enantiomers in any proportion or, where more than one asymmetric centre are present, contain diastereoisomers in all possible ratios. Typically one of the enantiomers has enhanced biological activity compared to the other possibilities.

Similarly, where there are disubstituted or trisubstituted alkenes, these may be present in E or Z form or as mixtures of both in any proportion.

Furthermore, compounds of formula (II) may be in equilibrium with alternative tautomeric forms. Thus, whilst compounds of formula (II) are depicted in the keto form, they may also exist in the alternative enol form as depicted in formula (II′) below.

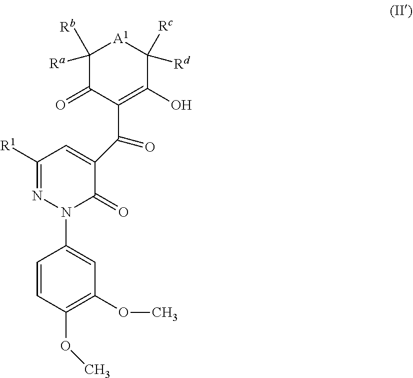

All tautomeric forms (single tautomer or mixtures thereof), racemic mixtures and single isomers are included within the scope of the present invention.

The present invention also provides agronomically acceptable salts of compounds of formula (II). Salts that the compounds of formula (II) may form with amines, including primary, secondary and tertiary amines (for example ammonia, dimethylamine and triethylamine), alkali metal and alkaline earth metal bases, transition metals or quaternary ammonium bases are preferred. Aluminium, calcium, cobalt, copper (copper (I), copper (II)), iron (iron (II), iron (III)), magnesium, potassium, sodium or zinc salts of compounds of formula (II) are particularly preferred, copper and sodium being especially preferred.

Compounds for use in the methods of the invention may be prepared by techniques known to the person skilled in the art of organic chemistry. Methods for the production of compounds of formula (I) are described in WO 2015/059262, WO 2015/052076, WO 2015/193202 and WO 2015/097043. Methods for the production of the compounds of formula (II) are described in WO 2012/136703.

Other herbicides of component (B) and additional mixing partners in three-way and multiple mixes as referred to herein using their common name are known, for example, from “The Pesticide Manual”, 15th Ed., British Crop Protection Council 2009. As noted in The Pesticide Manual, the herbicides (B) may also be in the form of esters or salts.

The safeners of the compositions of the invention may also be in the form of esters or salts, as mentioned e.g. in The Pesticide Manual, 15th Ed. (BCPC), 2009. Thus, the reference to cloquintocetmexyl also applies to cloquintocet and to a lithium, sodium, potassium, calcium, magnesium, aluminium, iron, ammonium, quaternary ammonium, sulfonium or phosphonium salt thereof as disclosed in WO02/34048 and the reference to fenchlorazole-ethyl also applies to fenchlorazole, etc.

The compositions utilised in the invention are generally formulated in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, micro-emulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents.

The formulations can be prepared e.g. by mixing the active ingredient(s) with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in very fine microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of about from 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the compositions according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxy-propanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in McCutcheon's Detergents and Emulsifiers Annual, MC Publishing Corp., Ridgewood N.J. (1981).

Further adjuvants that can be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The formulations according to the invention can include an additive comprising an oil of vegetable or animal origin, a mineral oil, alkyl esters of such oils or mixtures of such oils and oil derivatives. The amount of oil additive in the composition according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10^{th} Edition, Southern Illinois University, 2010.

The formulations generally comprise from 0.1 to 99% by weight, especially from 0.1 to 95% by weight, of components (A) and (B) and from 1 to 99.9% by weight of a formulation adjuvant which preferably includes from 0 to 25% by weight of a surface-active substance. Whereas commercial products may preferably be formulated as concentrates, the end user will normally employ dilute formulations.

The rates of application vary within wide limits and depend on the nature of the soil, the method of application, the crop plant, the pest to be controlled, the prevailing climatic conditions, and other factors governed by the method of application, the time of application and the target crop. As a general guideline compounds may be applied at a rate of from 1 to 2000 l/ha, especially from 10 to 1000 l/ha.

Preferred formulations can have the following compositions (weight %):

### Emulsifiable Concentrates:

active ingredients: 1 to 95%, preferably 60 to 90%
surface-active agent: 1 to 30%, preferably 5 to 20%
liquid carrier: 1 to 80%, preferably 1 to 35%

### Dusts:

active ingredients: 0.1 to 10%, preferably 0.1 to 5%
solid carrier: 99.9 to 90%, preferably 99.9 to 99%

### Suspension Concentrates:

active ingredients: 5 to 75%, preferably 10 to 50%
water: 94 to 24%, preferably 88 to 30%
surface-active agent: 1 to 40%, preferably 2 to 30%

### Wettable Powders:

active ingredients: 0.5 to 90%, preferably 1 to 80%
surface-active agent: 0.5 to 20%, preferably 1 to 15%
solid carrier: 5 to 95%, preferably 15 to 90%

### Granules:

active ingredients: 0.1 to 30%, preferably 0.1 to 15%
solid carrier: 99.5 to 70%, preferably 97 to 85%

The following Examples further illustrate, but do not limit, the invention.

| Wettable powders | a) | b) | c) |
|---|---|---|---|
| active ingredients | 25% | 50% | 75% |
| sodium lignosulfonate | 5% | 5% | — |
| sodium lauryl sulphate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| Kaolin | 62% | 27% | — |

The combination is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| active ingredients | 25% | 50% | 75% |
| light mineral oil | 5% | 5% | 5% |
| highly dispersed silicic acid | 5% | 5% | — |
| Kaolin | 65% | 40% | — |
| Talcum | — | | 20 |

The combination is thoroughly mixed with the adjuvants and the mixture is thoroughly ground in a suitable mill, affording powders that can be used directly for seed treatment.

| Emulsifiable concentrate | |
|---|---|
| active ingredients | 10% |
| octylphenol polyethylene glycol ether | 3% |
| (4-5 mol of ethylene oxide) | |
| calcium dodecylbenzenesulfonate | 3% |
| castor oil polyglycol ether (35 mol of ethylene oxide) | 4% |
| Cyclohexanone | 30% |
| xylene mixture | 50% |

Emulsions of any required dilution, which can be used in plant protection, can be obtained from this concentrate by dilution with water

| Dusts | a) | b) | c) |
|---|---|---|---|
| active ingredients | 5% | 6% | 4% |
| Talcum | 95% | — | — |
| Kaolin | — | 94% | — |
| mineral filler | — | — | 96% |

Ready-for-use dusts are obtained by mixing the combination with the carrier and grinding the mixture in a suitable mill. Such powders can also be used for dry dressings for seed.

| Extruded granules | |
|---|---|
| active ingredients | 15% |
| sodium lignosulfonate | 2% |
| Carboxymethylcellulose | 1% |
| Kaolin | 82% |

The combination is mixed and ground with the adjuvants, and the mixture is moistened with water. The mixture is extruded and then dried in a stream of air.

| Coated granules | |
|---|---|
| active ingredients | 8% |
| polyethylene glycol (mol. wt. 200) | 3% |
| Kaolin | 89% |

The finely ground combination is uniformly applied, in a mixer, to the kaolin moistened with polyethylene glycol. Non-dusty coated granules are obtained in this manner.

### Suspension Concentrate

| | |
|---|---|
| active ingredients | 40% |
| propylene glycol | 10% |
| nonylphenol polyethylene glycol ether (15 mol of ethylene oxide) | 6% |
| Sodium lignosulfonate | 10% |
| Carboxymethylcellulose | 1% |
| silicone oil (in the form of a 75% emulsion in water) | 1% |
| Water | 32% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Flowable Concentrate for Seed Treatment

| | |
|---|---|
| active ingredients | 40% |
| propylene glycol | 5% |
| copolymer butanol PO/EO | 2% |
| Tristyrenephenole with 10-20 moles EO | 2% |
| 1,2-benzisothiazolin-3-one (in the form of a 20% solution | 0.5% |
| in water) | |
| monoazo-pigment calcium salt | 5% |
| Silicone oil (in the form of a 75% emulsion in water) | 0.2% |
| Water | 45.3% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Slow Release Capsule Suspension

28 parts active ingredients are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 8-15 microns. The resulting formulation is applied to seeds as an aqueous suspension in an apparatus suitable for that purpose.

Throughout this document the expression “composition” stands for the various mixtures or combinations of components (A) and (B), for example in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the components (A) and (B) is not essential for working the present invention.

The term “herbicide” as used herein means a compound that controls or modifies the growth of plants. The term “herbicidally effective amount” means the quantity of such a compound or combination of such compounds that is capable of producing a controlling or modifying effect on the growth of plants. Controlling or modifying effects include all deviation from natural development, for example killing, retardation, leaf burn, albinism, dwarfing and the like.

The term “locus” as used herein means fields in or on which plants are growing, or where seeds of cultivated plants are sown, or where seed will be placed into the soil. It includes soil, seeds, and seedlings, as well as established vegetation.

The term “plants” refers to all physical parts of a plant, including seeds, seedlings, saplings, roots, tubers, stems, stalks, foliage, and fruits.

The term “plant propagation material” denotes all generative parts of a plant, for example seeds or vegetative parts of plants such as cuttings and tubers. It includes seeds in the strict sense, as well as roots, fruits, tubers, bulbs, rhizomes, and parts of plants.

The term “safener” as used herein means a chemical that when used in combination with a herbicide reduces the undesirable effects of the herbicide on non-target organisms, for example, a safener protects crops from injury by herbicides but does not prevent the herbicide from killing the weeds.

Crops of useful plants in which the composition according to the invention can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, okra, onion, pepper, potato, pumpkin, rhubarb, spinach and tomato; and vines for example grapes.

Crops are to be understood as being those which are naturally occurring, obtained by conventional methods of breeding, or obtained by genetic engineering. They include crops which contain so-called output traits (e.g. improved storage stability, higher nutritional value and improved flavour).

Crops are to be understood as also including those crops which have been rendered tolerant to herbicides like bromoxynil or classes of herbicides such as ALS-, EPSPS-, GS-, HPPD- and PPO-inhibitors. An example of a crop that has been rendered tolerant to imidazolinones, e.g. imazamox, by conventional methods of breeding is Clearfield® summer canola. Examples of crops that have been rendered tolerant to herbicides by genetic engineering methods include e.g. glyphosate- and glufosinate-resistant maize varieties commercially available under the trade names RoundupReady®, Herculex I® and LibertyLink®.

Crops are also to be understood as being those which naturally are or have been rendered resistant to harmful insects. This includes plants transformed by the use of recombinant DNA techniques, for example, to be capable of synthesising one or more selectively acting toxins, such as are known, for example, from toxin-producing bacteria. Examples of toxins which can be expressed include δ-endotoxins, vegetative insecticidal proteins (Vip), insecticidal proteins of bacteria colonising nematodes, and toxins produced by scorpions, arachnids, wasps and fungi.

An example of a crop that has been modified to express the Bacillus thuringiensis toxin is the Bt maize KnockOut® (Syngenta Seeds). An example of a crop comprising more than one gene that codes for insecticidal resistance and thus expresses more than one toxin is VipCot® (Syngenta Seeds). Crops or seed material thereof can also be resistant to multiple types of pests (so-called stacked transgenic events when created by genetic modification). For example, a plant can have the ability to express an insecticidal protein while at the same time being herbicide tolerant, for example Herculex I® (Dow AgroSciences, Pioneer Hi-Bred International).

Compositions of the invention can typically be used to control a wide variety of monocotyledonous and dicotyledonous weed species. Examples of monocotyledonous species that can typically be controlled include Alopecurus myosuroides, Avena fatua, Brachiaria plantaginea, Bromus tectorum, Cyperus esculentus, Digitaria sanguinalis, Echinochloa crus-galli, Lolium perenne, Lolium multiflorum, Panicum miliaceum, Poa annus, Setaria viridis, Setaria faberi and Sorghum bicolor. Examples of dicotyledonous species that can be controlled include Abutilon theophrasti, Amaranthus retroflexus, Bidens pilosa, Chenopodium album, Euphorbia heterophylla, Galium aparine, Ipomoea hederacea, Kochia scoparia, Polygonum convolvulus, Sida spinosa, Sinapis arvensis, Solanum nigrum, Stellaria media, Veronica persica and Xanthium strumarium.

In all aspects of the invention, in a particular embodiment, the weeds, e.g. to be controlled and/or growth-inhibited may be monocotyledonous or dicotyledonous weeds, which are tolerant or resistant to one or more other herbicides for example, HPPD inhibitor herbicides such as mesotrione, PSII inhibitor herbicides such as atrazine or EPSPS inhibitors such as glyphosate. Such weeds include, but are not limited to resistant Amaranthus biotypes.

Compositions of this invention can also be mixed with one or more further pesticides including fungicides, insecticides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection.

The compositions utilised in the invention can advantageously be used in the above-mentioned formulations (in which case “active ingredient” relates to the respective mixture of compound of formula (I) with the herbicide (B) or, when a safener is also used, the respective mixture of the compound of formula (I) with the herbicide (B) and the safener).

In general, the mixing ratio (by weight) of the compound of formula (I) to the herbicide (B) is from 0.01:1 to 100:1, more preferably from 0.05:1 to 20:1, even more preferably from 0.1:1 to 10:1 and most preferably from 0.2:1 to 5:1, for example, 0.6:1, 0.8:1, 1:1, 1.2:1, 1.3:1, 1.5:1, 2:1 and 3:1.

The amount of a composition according to the invention to be applied, will depend on various factors, such as the compounds employed; the subject of the treatment, such as, for example plants, soil or seeds; the type of treatment, such as, for example spraying, dusting or seed dressing; the purpose of the treatment, such as, for example prophylactic or therapeutic. In agricultural practice the application rates of the composition according to the invention depend on the type of effect desired, and typically range from 75 to 350 g of total composition per hectare.

Preferably the mixing ratio of compound of formula (I) to safener is from 100:1 to 1:10, especially from 20:1 to 1:1.

The compounds of the invention can be applied before or after planting of the crops, before weeds emerge (pre-emergence application) or after weeds emerge (post-emergence application). However, given that it has been found that the combination of (A) and (B) is particularly efficacious at low rates, whilst showing minimal phytotoxicity, the compositions are particularly effective when applied post-emergence to the weeds.

It is possible that the safener and the compositions of the invention are applied simultaneously. For example, the safener and the composition of the invention might be applied to the locus pre-emergence or might be applied to the crop post-emergence. It is also possible that the safener and the composition of the invention are applied sequentially. For example, the safener might be applied before sowing the seeds as a seed treatment and the composition of the invention might be applied to the locus pre-emergence or might be applied to the crop post-emergence.

The composition of the invention may show a synergistic effect. This occurs whenever the action of an active ingredient combination is greater than the sum of the actions of the individual components.

The action to be expected E for a given active ingredient combination obeys the so-called Colby Formula and can be calculated as follows (Colby, S. R., Calculating synergistic and antagonistic responses of herbicide combination, Weeds, Vol. 15, pages 20-22; 1967):
ppm=milligrams of active ingredient (a.i.) per liter
X=% action by first active ingredient using p ppm of the active ingredient
Y=% action by second active ingredient sing q ppm of the active ingredient.

According to Colby, the expected (additive) action of active ingredients A+B using p+q ppm of active ingredient is

$$E = X + Y - \frac{X \cdot Y}{100}$$

If the action actually observed O is greater than the expected action E then the action of the combination is super-additive, i.e. there is a synergistic effect. In mathematical terms, synergism corresponds to a positive value for the difference of (O−E). In the case of purely complementary addition of activities (expected activity), said difference (O−E) is zero. A negative value of said difference (O−E) signals a loss of activity compared to the expected activity.

However, besides the actual synergistic action with respect to herbicidal activity, the composition according to the invention may also have further surprising advantageous properties. Examples of such advantageous properties that may be mentioned are: more advantageuos degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

In addition, it is also possible that the composition of the invention may show increased crop tolerance, when compared with the effect of the compound A alone. This occurs when the action of an active ingredient combination is less damaging to a useful crop than the action of one of the active ingredients alone.

Various aspects and embodiments of the present invention will now be illustrated in more detail by way of example. It will be appreciated that modification of detail may be made without departing from the scope of the invention.

For the avoidance of doubt, where a literary reference, patent application, or patent, is cited within the text of this application, the entire text of said citation is herein incorporated by reference.

### EXAMPLES

### Preparation Examples

The following abbreviations were used in this section: s=singlet; bs=broad singlet; d=doublet; dd=double doublet; dt=double triplet; t=triplet, tt=triple triplet, q=quartet, sept=septet; m=multiplet; RT=retention time, MH⁺=molecular mass of the molecular cation.

1H NMR spectra were recorded at 400 MHz either on a Varian Unity Inova instrument 400 MHz or on a Bruker AVANCE—II instrument.

### Preparative Example 1

### Preparation of 6-[6-cyclopropyl-2-(3,4-dimethoxyphenyl)-3-oxo-pyridazine-4-carbonyl]-2,2,4,4-tetramethyl-cyclohexane-1,3,5-trione (Compound 2.11)

### STEP 1. Preparations of 2-Bromo-1-cyclopropyl-ethanone

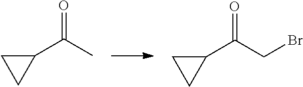

To a stirred solution of 1-cyclopropylethanone (50 g, 595 mmol) in MeOH (350 mL) at 0° C. (ice bath) was added bromine (32 mL, 595 mmol) dropwise over a period of 1 hour (the initial red colour of the reaction mixture became colourless by the end of the addition of bromine). The resulting solution was then stirred below 5° C. for 4 hours, then water (175 mL) was added and the reaction mixture stirred at room temperature for 16 hours. The reaction mixture was then poured into water (1000 mL) and extracted with CH₂Cl₂ (2×1000 mL). The combined organic layers was washed with saturated aqueous NaHCO₃ solution (500 mL), water (500 mL) and finally with brine (500 mL). The organic layer was dried over Na₂SO₄, filtered and concentrated in vacuo to give a light-brown oil. Pure 2-bromo-1-cyclopropyl-ethanone was obtained by vacuum distillation of this crude oil at 100° C. (59 g, 61%).

¹H NMR (400 MHz, CDCl₃) δ=4.01 (s, 2H), 2.22-2.17 (m, 1H), 1.14-1.11 (m, 2H), 1.03-0.99 (m, 2H).

### STEP 2. Preparation of diethyl 2-(2-cyclopropyl-2-oxo-ethyl)propanedioate

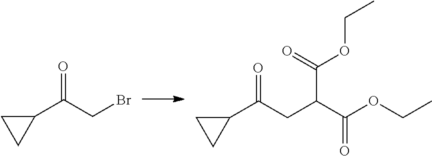 [SMILES: O=C(CBr)C1CC1 ; CCOC(=O)C(CC(=O)C1CC1)C(=O)OCC]

To a stirred solution of 2-bromo-1-cyclopropyl-ethanone (50 g, 307 mmol) in acetone (450 mL) at room temperature was added K₂CO₃ (64 g, 460 mmol), potassium iodide (1.5 g, 9.2 mmol) and diethylmalonate (54 g, 337 mmol) and the resulting mixture was heated at reflux (75° C.) for 16 hours. The reaction mixture was filtered and the filtrate concentrated in vacuo. The crude material was purified by column chromatography, eluting with 8% EtOAc in hexane to afford diethyl 2-(2-cyclopropyl-2-oxo-ethyl)propanedioate as a light yellow oil (40 g, 54%).

¹H NMR (400 MHz, CDCl₃) δ=4.24-4.13 (m, 4H), 3.95 (t, 1H), 3.18 (d, 2H), 1.98-1.92 (m, 1H), 1.26 (t, 6H), 1.06-1.03 (m, 2H), 0.93-0.88 (m, 2H).

### STEP 3. Preparation of ethyl 3-cyclopropyl-6-oxo-4,5-dihydro-1H-pyridazine-5-carboxylate

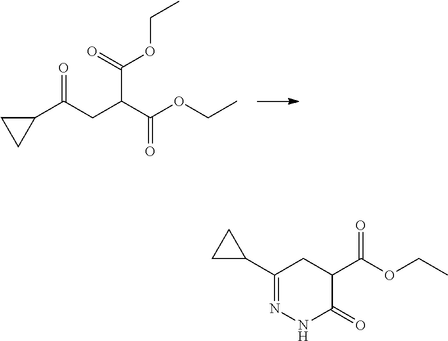 [SMILES: CCOC(=O)C(CC(=O)C1CC1)C(=O)OCC ; CCOC(=O)C1CC(C2CC2)=NNC1=O]

To a stirred solution of diethyl 2-(2-cyclopropyl-2-oxo-ethyl)propanedioate (70 g, 289 mmol) in EtOH (500 mL) between 0-5° C. (ice-water bath) was added hydrazine hydrate (16 mL, 318 mmol) dropwise and the resulting solution was stirred at room temperature for 20 hours. All volatiles were removed from the reaction mixture in vacuo to afford crude ethyl 3-cyclopropyl-6-oxo-4,5-dihydro-1H-pyridazine-5-carboxylate as a thick yellow oil (52 g, crude). This crude material was used in the next step without any further purification.

### STEP 4. Preparation of ethyl 3-cyclopropyl-6-oxo-1H-pyridazine-5-carboxylate

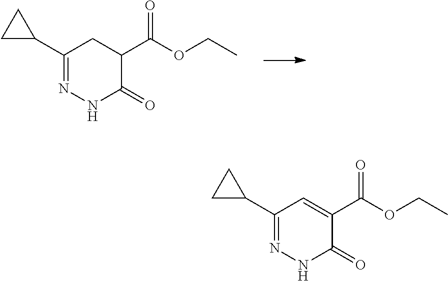

To a stirred solution of ethyl 3-cyclopropyl-6-oxo-4,5-dihydro-1H-pyridazine-5-carboxylate (52 g crude, 247 mmol) in AcOH (500 mL) between 10-15° C. was added a solution of bromine (20 mL, 317 mmol) in AcOH (200 mL) dropwise over a period of 30 minutes. The resultant solution was then stirred at room temperature for a further 30 minutes. The AcOH was removed from the reaction mixture in vacuo. To the residue was added EtOAc (2000 mL) and water (5000 mL) and the mixture shaken thoroughly. All insoluble particles were then removed by filtration through a Celite bed and then the filtrate layers were separated. The aqueous layer was extracted further with EtOAc (1000 mL). The combined EtOAc layers was then washed with saturated aqueous NaHCO₃ solution (500 mL), saturated aqueous Na₂₋S₂O₃ solution (500 mL) and finally with brine (500 mL). The organic layer was dried over Na₂SO₄, filtered and concentrated in vacuo. The crude material was purified by column chromatography eluting with 8% EtOAc in hexane to afford desired product as a light yellow solid. The solid was further purified by triturating with a 1% solution of EtOAc in hexane to afford ethyl 3-cyclopropyl-6-oxo-1H-pyridazine-5-carboxylate as an off white solid (17 g, 28% over two steps).

¹H NMR (400 MHz, CDCl₃) δ=11.17 (s, 1H), 7.65 (s, 1H), 4.40 (q, 2H), 1.92-1.85 (m, 1H), 1.38 (t, 3H), 1.02-0.98 (m, 2H), 0.92-0.88 (m, 2H).

### STEP 5. Preparation of ethyl 6-cyclopropyl-2-(3,4-dimethoxyphenyl)-3-oxo-pyridazine-4-carboxylate

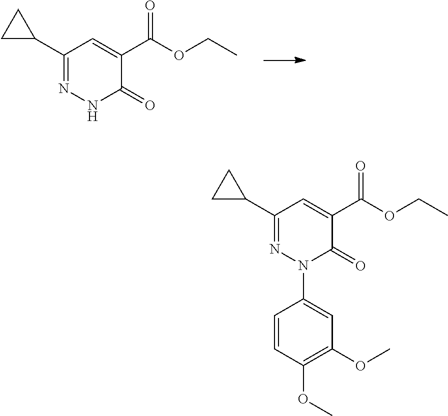 [SMILES: CCOC(=O)c1cc(C2CC2)n[nH]c1=O ; CCOC(=O)c1cc(C2CC2)nn(-c2ccc(OC)c(OC)c2)c1=O]

To a stirred solution of ethyl 3-cyclopropyl-6-oxo-1H-pyridazine-5-carboxylate (2.00 g, 9.61 mmol) in dichloromethane (70 mL) was added, 4 Å molecular sieves (0.88 g), copper(II) acetate monohydrate (4.01 g, 22.1 mmol), triethylamine (2.7 mL, 19.2 mmol) and pyridine (1.6 mL, 19.2 mmol). Then (3,4-dimethoxyphenyl)boronic acid (2.6 g, 14.4 mmol) was added portionwise over 10 minutes. The reaction mixture was stirred for 4 hours at room temperature with compressed air bubbling through. After 4 hours the compressed air was switched off and stirring continued for a further 16 hours. The reaction mixture was filtered through Celite washing the residue with additional CH₂Cl₂. The filtrate was washed with aqueous 2N HCl solution (2×100 mL) and saturated brine solution (100 mL). The organic layer was dried over MgSO₄, filtered and concentrated in vacuo to leave a dark yellow gum. Purification by column chromatography eluting with 0-100% EtOAc in isohexane afforded ethyl 6-cyclopropyl-2-(3,4-dimethoxyphenyl)-3-oxo-pyridazine-4-carboxylate as a bright yellow gum (2.46 g, 74%).

¹H NMR (400 MHz, CDCl3) δ=7.55 (s, 1H), 7.11 (m, 2H), 6.91 (d, 1H), 4.40 (q, 2H), 3.94 (s, 3H), 3.90 (s, 3H), 1.97 (m, 1H), 1.40 (t, 3H), 1.04 (m, 2H), 0.92 (m, 2H).

### STEP 6. Preparation of 6-Cyclopropyl-2-(3,4-dimethoxyphenyl)-3-oxo-pyridazine-4-carboxylic acid

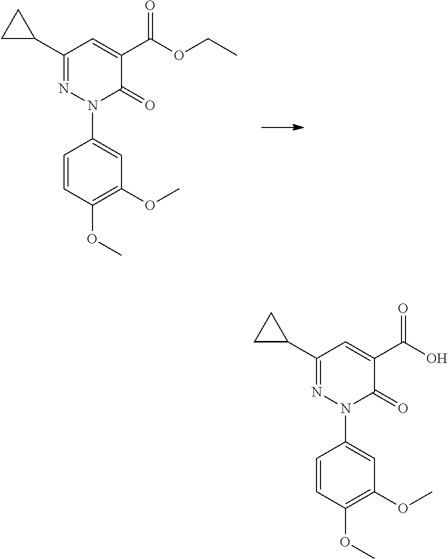 [SMILES: CCOC(=O)c1cc(C2CC2)nn(-c2ccc(OC)c(OC)c2)c1=O ; COc1ccc(-n2nc(C3CC3)cc(C(=O)O)c2=O)cc1OC]

To a solution of ethyl 6-cyclopropyl-2-(3,4-dimethoxyphenyl)-3-oxo-pyridazine-4-carboxylate (2.40 g, 6.97 mmol) in tetrahydrofuran (50 mL) was added water (25 mL) followed by lithium hydroxide (0.45 g, 10.5 mmol). The resultant solution was stirred at room temperature for 90 minutes. The THF was removed in vacuo and the remaining aqueous mixture diluted with water (25 mL) and washed with EtOAc (30 mL). The vigorously stirred aqueous layer was acidified until pH=1 with conc. HCl solution—a yellow precipitate forms in the process. This was collected by filtration affording 6-cyclopropyl-2-(3,4-dimethoxyphenyl)-3-oxo-pyridazine-4-carboxylic acid as a yellow solid (1.78 g, 81%).

¹H NMR (400 MHz, CDCl₃) δ=14.10 (br. s, 1H), 8.06 (s, 1H), 7.14 (m, 1H), 7.10 (m, 1H), 6.97 (d, 1H), 3.95 (s, 3H), 3.90 (s, 3H), 2.10 (m, 1H), 1.15 (m, 2H), 1.00 (m, 2H).

### STEP 7. Preparation of 6-[6-cyclopropyl-2-(3,4-dimethoxyphenyl)-3-oxo-pyridazine-4-carbonyl]-2,2,4,4-tetramethyl-cyclohexane-1,3,5-trione (Compound 2.11)

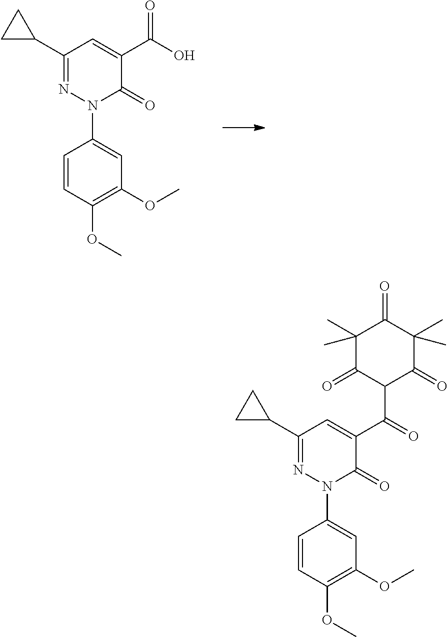 [SMILES: COc1ccc(-n2nc(C3CC3)cc(C(=O)O)c2=O)cc1OC ; COc1ccc(-n2nc(C3CC3)cc(C(=O)C3C(=O)C(C)(C)C(=O)C(C)(C)C3=O)c2=O)cc1OC]

Under a nitrogen atmosphere, to a solution of 6-cyclopropyl-2-(3,4-dimethoxyphenyl)-3-oxo-pyridazine-4-carboxylic acid (1.00 g, 3.16 mmol) in dichloromethane (anhydrous, 20 mL) in a 100 mL 3-neck round bottom flask was added N,N-dimethylformamide (anhydrous, 0.012 mL, 0.158 mmol) followed by oxalyl chloride (0.29 mL, 3.32 mmol) dropwise and the reaction mixture stirred at room temperature for 1 hour. The reaction mixture was cooled to 0° C. (salt/ice bath) and triethylamine (1.77 mL, 12.7 mmol) was added dropwise over 15 minutes, then stirred for 5 minutes at 0° C. before 2,2,4,4-tetramethylcyclohexane-1,3,5-trione (0.58 g, 3.17 mmol) dissolved in minimum CH₂Cl₂ was added dropwise over 15 minutes. The resultant solution was stirred at 0° C. for 5 minutes then 1 hour at room temperature. The reaction mixture was cooled to 0° C. and further triethylamine (1.77 mL, 12.7 mmol) was added dropwise over 10 minutes followed by acetone cyanohydrin (0.044 mL, 0.475 mmol). The reaction mixture was stirred at 0° C. for 5 minutes then heated at reflux (40° C.) for 90 minutes. The reaction mixture was allowed to cool to room temperature, filtered and the filtrate concentrated in vacuo. Purification by column chromatography eluting with a mixed solvent system of 20:8:4:4:1 Toluene:Dioxane:EtOH:Et₃N:Water afforded the triethylamine salt of the desired compound. The crude oil was dissolved in MeOH and loaded onto a solid-phase-extraction SAX cartridge. The column was flushed with 3 column volumes of MeOH and then the desired product released with 1% formic acid in MeOH, concentrating in vacuo to afford 6-[6-cyclopropyl-2-(3,4-dimethoxyphenyl)-3-oxo-pyridazine-4-carbonyl]-2,2,4,4-tetramethyl-cyclohexane-1,3,5-trione (0.31 g, 20%) as a crushed orange foam.

¹H NMR (400 MHz, CDCl₃) δ=7.13 (s, 1H), 7.12-7.06 (m, 2H), 6.91 (d, 1H), 3.91 (s, 3H), 3.88 (s, 3H), 2.00-1.92 (m, 1H), 1.52 (br. s, 6H), 1.40 (br. s, 6H), 1.05-0.98 (m, 2H), 0.98-0.91 (m, 2H).

### Preparative Example 2

### Preparation of 2-[6-cyclopropyl-2-(3,4-dimethoxyphenyl)-3-oxo-pyridazine-4-carbonyl]-5-methyl-cyclohexane-1,3-dione (Compound 2.8)

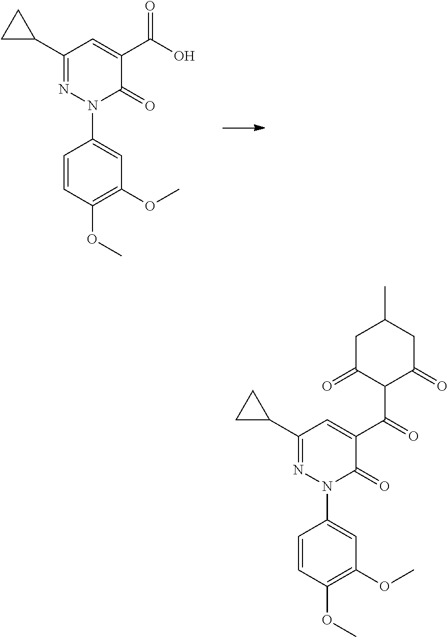 [SMILES: COc1ccc(-n2nc(C3CC3)cc(C(=O)O)c2=O)cc1OC ; COc1ccc(-n2nc(C3CC3)cc(C(=O)C3C(=O)CC(C)CC3=O)c2=O)cc1OC]

6-cyclopropyl-2-(3,4-dimethoxyphenyl)-3-oxo-pyridazine-4-carboxylic acid (1.00 g, 3.16 mmol) was taken in dry DCM (20 mL) and to it one drop of dry DMF was added. Then oxalylchloride (0.35 mL, 4.11 mmol) was added dropwise to the mixture & stirred for 1 h. The reaction mixture was concentrated under reduced pressure in nitrogen atmosphere. Then the crude reaction mass was dissolved in dry DCM (15 mL), activated molecular sieves was added & cooled the reaction mixture in ice salt bath. Then triethylamine (1.23 mL, 9.48 mmol) was added dropwise to the reaction mixture over 15 min. followed by 5-methyl-1,3-cyclohexane dione (479 mg, 3.79 mmol) in DCM (10 mL) was added dropwise to the reaction mixture. Stirred at room temperature for 1 h. Then triethylamine (1.23 mL, 9.48 mmol) and acetone cyanohydrin (0.22 mL, 2.37 mmol) were added and the reaction was stirred for 2.5 h. The crude was diluted with DCM & washed with 1 N HCl. Purification by column chromatography eluting with a mixed solvent system of 20:8:4:4:1 Toluene:Dioxane:EtOH:Et₃N:Water afforded the triethylamine salt of the desired compound as a brown gum. To this was added water (25 mL) and CH₂Cl₂ (25 mL) and this was acidified to pH 1 with 2M HCl. The mixture was stirred for 5 minutes, then the phases separated through a phase separation cartridge, washing with further CH₂Cl₂. The organic phase was concentrated to afford the desired product 2-[6-cyclopropyl-2-(3,4-dimethoxyphenyl)-3-oxo-pyridazine-4-carbonyl]-5-methyl-cyclohexane-1,3-dione (850 mg, 2.00 mmol, 63%) as a solid.

¹H NMR (400 MHz, CDCl₃) δ=7.14-7.10 (2H, m), 6.98 (1H, s), 6.89 (1H, d), 3.89 (3H, s), 3.87 (3H, s), 2.75-2.71 (1H, m), 2.53-2.39 (2H, m), 2.32-2.26 (1H, m), 2.18-2.12 (1H, m), 1.97-1.90 (1H, m), 1.08 (3H, d), 0.99-0.95 (2H, m), 0.93-0.87 (2H, m).

### Preparative Example 3

### Preparation of 2-[2-(3,4-Dimethoxyphenyl)-6-methyl-3-oxo-pyridazine-4-carbonyl]cyclohexane-1,3-dione (compound 2.3)

### STEP 1. Preparation of 1-Bromopropan-2-one

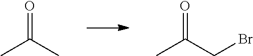

Acetone (150 g, 2.58 mol), water (480 mL) and glacial acetic acid (90 mL) were stirred in a two-necked round bottom flask and heated to reflux (75° C.). Bromine (73.2 mL, 2.84 mol) was added portionwise to the solution. The reaction mixture continued to be heated at 75° C. until it turned colourless. It was then cooled to 0° C. (ice-bath) and water added (100 mL) followed by sufficient Na₂CO₃ until it was no longer acidic. The reaction mixture was transferred to a separating funnel and the bottom organic layer separated, dried over Na₂SO₄ and filtered to afford 1-bromopropan-2-one (99.0 g, 28%).

¹H NMR (CDCl₃, 400 MHz) δ=3.23 (s, 2H), 1.67-1.72 (m, 3H).

### STEP 2. Preparation of diethyl 2-acetonylpropanedioate

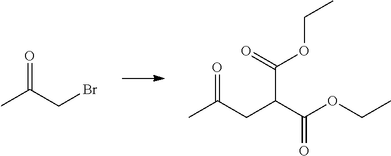

1-Bromopropan-2-one (90 g, 0.66 mol) was dissolved in acetone (740 mL) and under a nitrogen atmosphere diethylmalonate (126 mL, 0.79 mol), K₂CO₃ (136 g, 0.99 mol) and KI (3.27 g, 19.7 mmol) were added to the stirred solution. The reaction mixture was heated at reflux for 16 hours. The reaction mixture was filtered and the filtrate concentrated in vacuo. The crude material was dissolved in EtOAc and washed with water followed by brine. The organic layer was dried over Na₂SO₄, filtered and concentrated in vacuo to afford a liquid. This crude product was purified by column chromatography eluting with 0-5% MeOH in CH₂Cl₂ to afford diethyl 2-acetonylpropanedioate as a pale yellow oil (80.0 g, 56%).

¹H NMR (CDCl₃, 400 MHz) δ=4.21-4.04 (m, 4H), 3.78 (t, 1H), 2.99 (d, 2H), 2.20-2.06 (m, 3H), 1.27-1.13 ppm (m, 6H).

### STEP 3. Preparations of ethyl 3-methyl-6-oxo-4,5-dihydro-1H-pyridazine-5-carboxylate

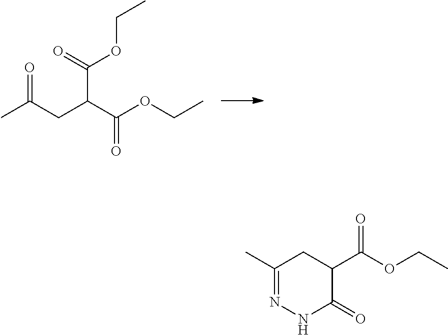

Diethyl 2-acetonylpropanedioate (80 g, 370 mmol) was dissolved in absolute ethanol (175 mL) and cooled to 0° C. To the stirred solution was added hydrazine hydrate (20.4 mL, 407 mmol) dropwise. The mixture was allowed to warm to room temperature and stirred for 16 hours. The reaction mixture was concentrated in vacuo and the resultant crude ethyl 3-methyl-6-oxo-4,5-dihydro-1H-pyridazine-5-carboxylate was used directly in the next step without further purification (61.0 g crude, 90%).

### STEP 4. Preparation of ethyl 3-methyl-6-oxo-1H-pyridazine-5-carboxylate

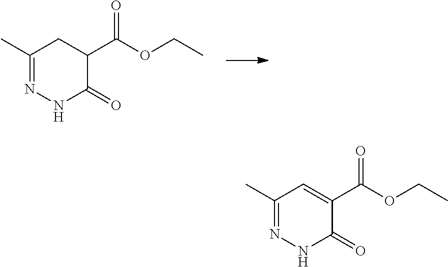

A solution of bromine (17 mL, 662 mmol) in acetic acid (140 mL) was added portionwise to a stirred solution of ethyl 3-methyl-6-oxo-4,5-dihydro-1H-pyridazine-5-carboxylate (61 g crude, 331 mmol) in acetic acid (1250 mL). The reaction mixture was stirred at room temperature for 1 hour then concentrated in vacuo. The crude material was dissolved in EtOAc and this solution washed with water followed by brine, dried over Na₂SO₄, filtered and concentrated in vacuo. The crude material was purified by column chromatography eluting with 0-5% MeOH in CH₂Cl₂ to afford ethyl 3-methyl-6-oxo-1H-pyridazine-5-carboxylate as an off-white solid (22.0 g, 37%).

¹H NMR (CDCl₃, 400 MHz) δ=7.71 (s, 1H), 4.40 (q, 2H), 2.39 (s, 3H), 1.39 (t, 3H).

### STEP 5. Preparation of ethyl 2-(3,4-dimethoxyphenyl)-6-methyl-3-oxo-pyridazine-4-carboxylate

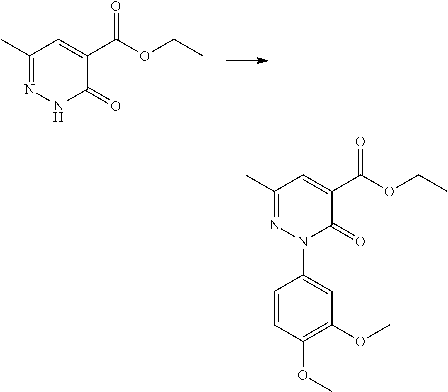 [SMILES: CCOC(=O)c1cc(C)n[nH]c1=O ; CCOC(=O)c1cc(C)nn(-c2ccc(OC)c(OC)c2)c1=O]

To a solution of ethyl 3-methyl-6-oxo-1H-pyridazine-5-carboxylate (5.0 g, 27.4 mmol) in dichloromethane (200 mL) was added copper(II) acetate monohydrate (12.6 g, 63.1 mmol), 4 Å molecular sieves, pyridine (4.4 mL, 54.9 mmol) and triethylamine (7.7 mL, 54.9 mmol). To the stirred suspension was added (3,4-dimethoxyphenyl)boronic acid (7.0 g, 38.4 mmol) portionwise over 5 minutes and the reaction mixture stirred at room temperature for 16 hours. The reaction mixture was filtered through Celite washing the residue with further CH₂Cl₂. The filtrate was washed with aqueous 2N HCl solution (2×200 mL), dried over MgSO₄, filtered and concentrated in vacuo. Purification by column chromatography eluting with 20-100% EtOAc in isohexane afforded ethyl 2-(3,4-dimethoxyphenyl)-6-methyl-3-oxo-pyridazine-4-carboxylate as a pale yellow solid (5.10 g, 58%).

¹H NMR (400 MHz, CDCl₃) δ=7.66 (s, 1H), 7.11 (br. s, 2H), 6.93 (d, 1H), 4.41 (q, 2H), 3.92 (s, 3H), 3.90 (s, 3H), 2.44 (s, 3H), 1.39 (t, 3H).

### STEP 6. Preparation of 2-(3,4-Dimethoxyphenyl)-6-methyl-3-oxo-pyridazine-4-carboxylic acid

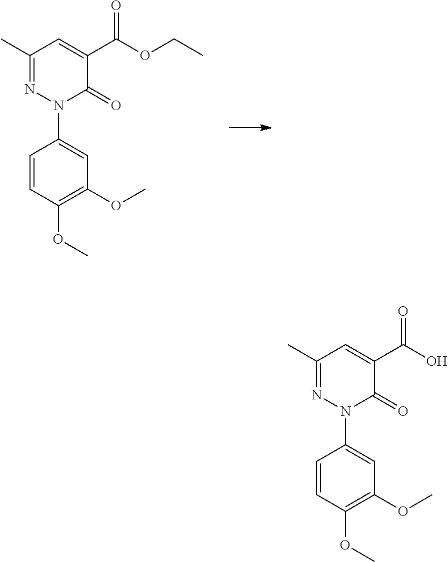

To a solution of ethyl 2-(3,4-dimethoxyphenyl)-6-methyl-3-oxo-pyridazine-4-carboxylate (12.0 g, 37.7 mmol) in tetrahydrofuran (200 mL) cooled to 0° C. (ice-bath) was added a solution of lithium hydroxide monohydrate (2.37 g, 56.5 mmol) in water (100 mL). The reaction mixture was allowed to warm to room temperature and stirred for 30 minutes. The THF was removed in vacuo and the aqueous mixture washed with CH₂Cl₂ (3×40 mL). The aqueous solution was cooled to 0° C., and stirred while conc. HCl solution was added until pH=1 was achieved. A bright yellow solid precipitated out in the process. This solid was collected by filtration. The solid was dissolved in CH₂Cl₂ and the solution dried over MgSO₄, filtered and concentrated in vacuo to afford 2-(3,4-dimethoxyphenyl)-6-methyl-3-oxo-pyridazine-4-carboxylic acid as a bright yellow solid (9.5 g, 87%).

¹H NMR (400 MHz, CDCl₃) δ=14.01 (br. s, 1H), 8.18 (s, 1H), 7.16 (d, 1H), 7.08 (br. s, 1H), 6.98 (d, 1H), 3.94 (app. d, 6H), 2.55 (s, 3H).

### STEP 7. Preparation of 2-[2-(3,4-Dimethoxyphenyl)-6-methyl-3-oxo-pyridazine-4-carbonyl]cyclohexane-1,3-dione (Compound 2.3)

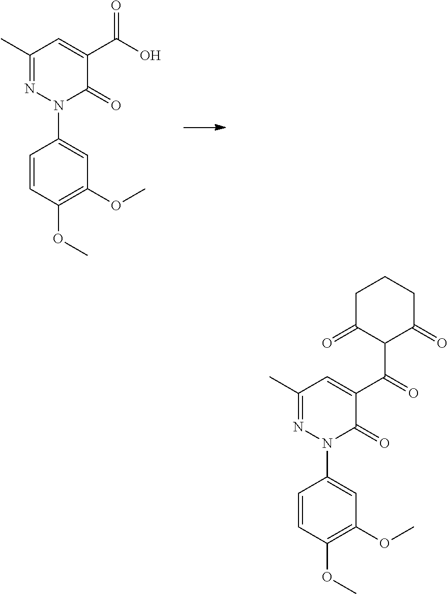

To a solution of 2-(3,4-dimethoxyphenyl)-6-methyl-3-oxo-pyridazine-4-carboxylic acid (1.00 g, 3.44 mmol) in dichloromethane (anhydrous, 13 mL) was added 3 drops of N,N-dimethylformamide (anhydrous) followed by dropwise addition of oxalyl chloride (0.33 mL, 3.79 mmol). The reaction mixture was stirred at room temperature for 16 hours. Further DMF (1 drop) and oxalyl chloride (0.1 mL) were added and stirring continued at room temperature for 1 hour. To a cooled (0° C. (ice bath)) solution of cyclohexane-1,3-dione (0.41 g, 3.62 mmol) in dichloromethane (anhydrous, 7.0 mL) was added triethylamine (1.44 mL, 10.3 mmol). The acid chloride solution was then added to the cyclohexane-1,3-dione-triethylamine solution via syringe pump over 10 minutes (70 mL/h) and the reaction mixture was stirred at 0° C. for a further 5 minutes. Further triethylamine (0.48 mL, 3.45 mmol) was added followed by acetone cyanohydrin (as a stock solution in anhydrous CH₂Cl₂) (10 mol %, 0.34 mmol). The reaction flask was transferred to a pre-heated oil bath and heated with stirring at reflux (40° C.) for 6 hours and then left stirring at room temperature for a further 16 hours. The reaction mixture was concentrated in vacuo to afford a black residue. Purification by column chromatography eluting with a mixed solvent system of 20:8:4:4:1 Toluene:Dioxane:EtOH:Et₃N:Water afforded the triethylamine salt of the desired compound as a brown gum. To this was added water (25 mL) and CH₂Cl₂ (25 mL) and this was acidified to pH 1 with 2M HCl. The mixture was stirred for 5 minutes, then the phases separated through a phase separation cartridge, washing with further CH₂Cl₂. The organic phase was concentrated to afford 2-[2-(3,4-dimethoxyphenyl)-6-methyl-3-oxo-pyridazine-4-carbonyl]cyclohexane-1,3-dione as an orange foam (400 mg, 30% yield).

¹H NMR (400 MHz, CDCl₃) δ=16.14 (1H, s), 7.13 (1H, dd), 7.09 (2H, m), 6.92 (1H, d), 3.90 (3H, s), 3.89 (3H, s), 2.73 (3H, t), 2.46 (3H, t), 2.41 (3H, s), 2.04 (2H, quintet).

### Preparative Example 4

### Preparation of 3-[2-(3,4-dimethoxyphenyl)-6-methyl-3-oxo-pyridazine-4-carbonyl]bicyclo[3.2.1]octane-2,4-dione (compound 2.1)

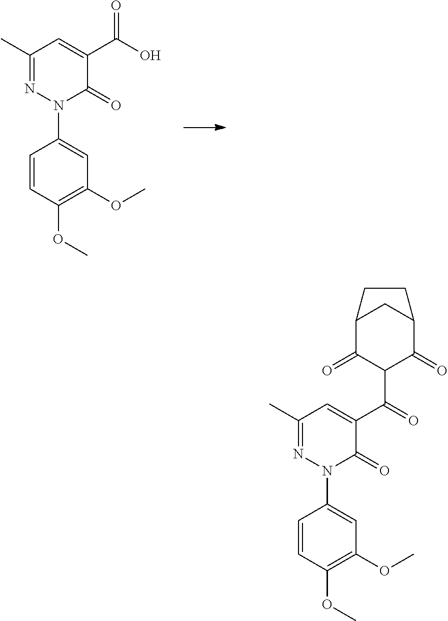

DMF (cat.) and oxalylchloride (0.6 mL) were added to a stirred suspension of 2-(3,4-dimethoxyphenyl)-6-methyl-3-oxo-pyridazine-4-carboxylic acid (1.5 g, 5.172 mmol) in DCM (20 mL). The reaction mixture was stirred at room temperature for 1.5 h. TLC (after quenching with MeOH) showed a non-polar spot formed. The reaction mass was evaporated under N2 atmosphere. DCM (20 mL) was added followed by a pinch of molecular sieve. TEA (2.2 mL) and bicyclo[3.2.1]octane-2,4-dione (0.86 g, 6.2 mmol) were added to acid chloride solution. The reaction mixture was stirred at room temperature for 1 h. Triethylamine (2.2 mL) and 25 drops of acetonecyanohydrin were added and stirred for 2 h. The reaction mass was purified by chromatography in with a mixed solvent system of 20:8:4:4:1 Toluene:Dioxane:EtOH:Et₃N:Water and then acidified by 10% HCl solution, extracted with DCM. The solvent was evaporated to get crude compound which was further purified by chromatography with acetone-DCM to afford the desired product 3-[2-(3,4-dimethoxyphenyl)-6-methyl-3-oxo-pyridazine-4-carbonyl]bicyclo[3.2.1]octane-2,4-dione (500 mg, 1.22 mmol, 24%) as a solid.

¹H NMR (400 MHz, CDCl₃) δ=16.19 (1H, s), 7.16-7.09 (3H, m), 6.93 (1H, d), 3.91 (6H, s), 3.11 (1H, t), 2.94 (1H, t), 2.42 (3H, s), 2.26-2.06 (3H, m), 2.04-1.98 (1H, m), 1.83 (1H, brm), 1.72 (1H, dt).

TABLE P1
Examples of herbicidal compounds of the present invention.

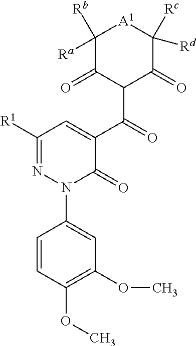

| Cmp | A¹ | R^{a} | R^{c} | R^{b} | R^{d} | R¹ | ¹H NMR (400 MHz, CDCl₃) |
|---|---|---|---|---|---|---|---|
| 2.1 | CH₂ | —CH₂—CH₂— | | H | H | CH₃ | 16.19 (1H, s), 7.16-7.09 (3H, m), 6.93 (1H, d), 3.91 (6H, s), 3.11 (1H, t), 2.94 (1H, t), 2.42 (3H, s), 2.26- 2.06 (3H, m), 2.04-1.98 (1H, m), 1.83 (1H, brm), 1.72 (1H, dt) |
| 2.2 | CHCH₃ | H | H | H | H | CH₃ | 16.07 (1H, s), 7.12 (1H, d), 7.08 (2H, m), 6.90 (1H, d), 3.89 (3H, s), 3.88 (3H, s), 2.76-2.71 (1H, m), 2.53-2.42 (2H, m), 2.40 (3H, s), 2.34-2.29 (1H, m), 2.19-2.12 (1H, m), 1.08 (3H, d). |
| 2.3 | CH₂ | H | H | H | H | CH₃ | 16.14 (1H, s), 7.13 (1H, dd), 7.09 (2H, m), 6.92 (1H, d), 3.90 (3H, s), 3.89 (3H, s), 2.73 (3H, t), 2.46 (3H, t), 2.41 (3H, s), 2.04 (2H, quintet). |
| 2.4 | C(CH₃)₂ | H | H | H | H | CH₃ | 16.14 (1H, s), 7.13-7.08 (3H, m), 6.90 (1H, s), 3.89 (3H, s), 3.88 (3H, s), 2.60 (2H, s), 2.90 (3H, s), 2.34 (2H, s), 1.10 (6H, s). |
| 2.5 | C═O | CH₃ | CH₃ | CH₃ | CH₃ | CH₃ | 7.22 (s, 1H), 7.13- 7.02 (m, 2H), 6.92 (d, J = 8.6 Hz, 1H), 3.91 (s, 3H), 3.89 (s, 3H), 2.43 (s, 3H), 1.53 (s, 6H), 1.40 (br. s., 6H) |
| 2.6 | CHC₂H₅ | H | H | H | H | CH₃ | 16.10 (br. s., 1H) 7.04-7.26 (m, 3H) 6.92 (d, 1H) 3.90 (s, 3H) 3.89 (s, 3H) 2.76 (brs., 1H) 2.55 (brs, 1H) 2.33-2.50 (m, 4H) 2.13 (brs, 2H) 1.34-1.51 (m, 2H) 0.94 (t, 3H) |
| 2.7 | CH₂ | CH₃ | CH₃ | CH₃ | CH₃ | CH₃ | |
| 2.8 | CHCH₃ | H | H | H | H | cPr | 7.14-7.10 (2H, m), 6.98 (1H, s), 6.89 (1H, d), 3.89 (3H, s), 3.87 (3H, s), 2.75-2.71 (1H, m), 2.53-2.39 (2H, m), 2.32-2.26 (1H, m), 2.18-2.12 (1H, m), 1.97-1.90 (1H, m), 1.08 (3H, d), 0.99- 0.95 (2H, m), 0.93-0.87 (2H, m). |
| 2.9 | CH₂ | —CH₂—CH₂— | | H | H | cPr | 16.18 (1H, s), 7.14-7.10 (2H, m), 6.96 (1H, s), 6.89 (1H, d), 3.89 (3H, s), 3.88 (3H, s), 3.08 (1H, t), 2.91 (1H, t), 2.23-1.89 (5H, m), 1.86-1.77 (1H, m), 1.69 (1H, dt), 1.01-0.94 (2H, m), 0.92-0.87 (2H, m). |
| 2.10 | C(CH₃)₂ | H | H | H | H | cPr | 16.15 (1H, s), 7.16-7.10 (2H, m), 7.00 (1H, s), 6.88 (1H, d), 3.89 (3H, s), 3.87 (3H, s), 2.59 (2H, s), 2.33 (2H, s), 1.97-1.90 (1H, m), 1.09 (6H, s), 1.01-0.95 (2H, m), 0.93-0.89 (2H, m). |
| 2.11 | C═O | CH₃ | CH₃ | CH₃ | CH₃ | cPr | 7.13 (s, 1H), 7.12-7.06 (m, 2H), 6.91 (d, J = 8.6 Hz, 1H), 3.91 (s, 3H) 3.88 (s, 3H), 2.00- 1.92 (m, 1H), 1.52 (br. s., 6H), 1.40 (br. s., 6H), 1.05-0.98 (m, 2H), 0.98- 0.91 (m, 2H) |
| 2.12 | CH₂ | H | H | H | H | cPr | 16.16 (1H, s), 7.14-7.10 (2H, m), 6.98 (1H, s), 6.89 (1H, d), 3.89 (3H, s), 3.87 (3H, s), 2.71 (2H, t), 2.44 (2H, t), 2.06-2.00 (2H, m), 1.97-1.91 (1H, m), 1.01-0.95 (2H, m), 0.93-0.90 (2H, m). |
| 2.13 | O | CH₃ | CH₃ | CH₃ | CH₃ | CH₃ | 7.15 (s, 1H), 7.10 (m, 2H), 6.90 (d, 2H), 3.90 (s, 3H), 3.88 (s, 3H), 2.41 (s, 3H), 1.58 (s, 6H), 1.42 (s, 6H) |
| 2.14 | O | CH₃ | CH₃ | CH₃ | CH₃ | cPr | 7.27 (s, 1H), 7.11 (d, 2H), 6.90 (d, 2H), 3.92 (s, 3H), 3.87 (s, 3H), 1.95 (m, 1H), 1.58 (s, 6H), 1.41 (s, 6H), 1.01 (m, 2H), 0.94 (m, 2H) |

### Biological Examples

B1: Herbicidal Activity of the Compounds of Formula (II)

Seeds of a variety of test species HORVW (Hordeum vulgare—barley), ABUTH (Abutilon theophrasti), AMARE (Amaranthus retroflexus) and ECHCG (Echinochloa crus-galli) were sown in standard soil in pots. After cultivation for 10 days cultivation under controlled conditions in a glasshouse (at 24/16° C., day/night; 14 hours light; 65% humidity), the plants were sprayed with an aqueous spray solution derived from the formulation of the technical active ingredient in 0.6 ml acetone and 45 ml formulation solution containing 10.6% Emulsogen EL (Registry number 61791-12-6), 42.2% N-methyl pyrrolidone, 42.2% dipropylene glycol monomethyl ether (CAS RN 34590-94-8) and 0.2% X-77 (CAS RN 11097-66-8).

The test plants were then grown in a glasshouse under controlled conditions in a glasshouse (at 24/16° C., day/night; 14 hours light; 65% humidity) and watered twice daily. After 14 days, the test was evaluated (100=total damage to plant; 0=no damage to plant).

TABLE B1

| | | Plant Species | | | |
|---|---|---|---|---|---|
| Compound | Rate g/ha | HORVW | ECHCG | ABUTH | AMARE |
| 2.1 | 250 | 0 | 100 | 100 | 100 |
| | 125 | 0 | 100 | 100 | 100 |
| 2.2 | 250 | 0 | 100 | 100 | 100 |
| | 125 | 0 | 100 | 100 | 100 |
| 2.3 | 250 | 0 | 100 | 100 | 100 |
| | 125 | 0 | 100 | 100 | 100 |
| 2.4 | 250 | 10 | 100 | 100 | 100 |
| | 125 | 0 | 100 | 100 | 100 |
| 2.5 | 250 | 0 | 90 | 100 | 100 |
| | 125 | 0 | 90 | 100 | 100 |
| 2.9 | 250 | 10 | 100 | 100 | 100 |
| | 125 | 0 | 100 | 100 | 90 |
| 2.11 | 250 | 0 | 100 | 100 | 100 |
| | 125 | 0 | 100 | 100 | 100 |

These results demonstrate that the compounds of the formula (II) confer little if any damage when applied to barley (HORVW) but still provide good control of representative weed species (ECHCG, ABUTH, AMARE).

B2: Herbicidal Activity of a Mixture of Compound 1.4 with (i) Mesotrione and (ii) Compound 2.3

Seeds of a variety of test species were used in drilled field trials to look at the control of important weed species present in corn crops as well as the effect on soybean (a volunteer crop in corn). Trials were carried out in Brazil in the summer season.

Plot size was 10-12 m², and two replicates were carried out per treatment. Plants were treated post-emergence at the 4 leaf stage. Fungicides and insecticides were used as necessary for plant health. The test was evaluated at 7 and 30 days after application (Amaranthus viridis (AMAVI), Bidens pilosa (BIDPI), Euphorbia heterophylla (EPPHL)) and 9 and 37 days after application (Brachiaria plantaginea (BRAPL) and soybean (Glycine max GLXMA) with 100=total damage to plant and 0=no damage to plant.

The treatment list is shown in Table B2

TABLE B2

| Treatment | Compound | Formulation | g ai/ha |
|---|---|---|---|
| 1 | 1.4 | EC100 | 75 |
| 2 | 1.4 | EC100 | 100 |
| 3 | 1.4 | EC100 | 150 |
| 4 | 2.3 | WP10 | 100 |
| 5 | Mesotrione | CALLISTO ® (SC480) | 75 |
| 6 | Mesotrione | CALLISTO ® (SC480) | 125 |
| 7 | 1.4 + 2.3 | EC100 + WP10 | 75 + 50 |
| 8 | 1.4 + 2.3 | EC100 + WP10 | 100 + 50 |
| 9 | 1.4 + 2.3 | EC100 + WP10 | 150 + 50 |
| 10 | 1.4 + Mesotrione | EC100 + CALLISTO ® | 75 + 75 |
| | | (SC480) | |
| 11 | 1.4 + Mesotrione | EC100 + CALLISTO ® | 100 + 75 |
| | | (SC480) | |
| 12 | 1.4 + Mesotrione | EC100 + CALLISTO ® | 150 + 75 |
| | | (SC480) | |
| 13 | 1.4 + Mesotrione | EC100 + CALLISTO ® | 75 + 125 |
| | | (SC480) | |
| 14 | 1.4 + Mesotrione | EC100 + CALLISTO ® | 100 + 125 |
| | | (SC480) | |
| 15 | 1.4 + Mesotrione | EC100 + CALLISTO ® | 150 + 125 |
| | | (SC480) | |

Observed results are shown in Tables B3.1 to B3.5 below. Expected results were calculated using the Colby Formula.

TABLE B3.1

| | | | AMAVI 7DAA | | AMAVI 30 DAA | |
|---|---|---|---|---|---|---|
| Treat- | | | | Ex- | | Ex- |
| ment | Compound | g ai/ha | Observed | pected | Observed | pected |
| 1 | 1.4 | 75 | 10 | | 13 | |
| 2 | 1.4 | 100 | 20 | | 20 | |
| 3 | 1.4 | 150 | 40 | | 40 | |
| 4 | 2.3 | 100 | 65 | | 70 | |
| 5 | Mesotrione | 75 | 25 | | 30 | |
| 6 | Mesotrione | 125 | 65 | | 50 | |
| 7 | 1.4 + 2.3 | 75 + 50 | 88 | 69 | 68 | 74 |
| 8 | 1.4 + 2.3 | 100 + 50 | 93 | 72 | 85 | 76 |
| 9 | 1.4 + 2.3 | 150 + 50 | 95 | 79 | 100 | 82 |
| 10 | 1.4 + | 75 + 75 | 100 | 33 | 85 | 39 |
| | Mesotrione | | | | | |
| 11 | 1.4 + | 100 + 75 | 93 | 40 | 83 | 44 |
| | Mesotrione | | | | | |
| 12 | 1.4 + | 150 + 75 | 95 | 55 | 87 | 58 |
| | Mesotrione | | | | | |
| 13 | 1.4 + | 75 + 125 | 100 | 69 | 95 | 56 |
| | Mesotrione | | | | | |
| 14 | 1.4 + | 100 + 125 | 98 | 72 | 93 | 60 |
| | Mesotrione | | | | | |
| 15 | 1.4 + | 150 + 125 | 100 | 79 | 100 | 70 |
| | Mesotrione | | | | | |

TABLE B3.2

| | | | BIDPI 7DAA | | BIDPI 30 DAA | |
|---|---|---|---|---|---|---|
| Treat- | | | | Ex- | | Ex- |
| ment | Compound | g ai/ha | Observed | pected | Observed | pected |
| 1 | 1.4 | 75 | 8 | | 8 | |
| 2 | 1.4 | 100 | 10 | | 13 | |
| 3 | 1.4 | 150 | 28 | | 20 | |
| 4 | 2.3 | 100 | 45 | | 43 | |
| 5 | Mesotrione | 75 | 28 | | 28 | |
| 6 | Mesotrione | 125 | 40 | | 40 | |
| 7 | 1.4 + 2.3 | 75 + 50 | 93 | 49 | 93 | 47 |
| 8 | 1.4 + 2.3 | 100 + 50 | 98 | 51 | 90 | 50 |
| 9 | 1.4 + 2.3 | 150 + 50 | 95 | 60 | 90 | 54 |
| 10 | 1.4 + | 75 + 75 | 78 | 33 | 73 | 33 |
| | Mesotrione | | | | | |
| 11 | 1.4 + | 100 + 75 | 93 | 35 | 78 | 37 |
| | Mesotrione | | | | | |
| 12 | 1.4 + | 150 + 75 | 93 | 47 | 70 | 42 |
| | Mesotrione | | | | | |
| 13 | 1.4 + | 75 + 125 | 93 | 45 | 90 | 45 |
| | Mesotrione | | | | | |
| 14 | 1.4 + | 100 + 125 | 100 | 46 | 100 | 48 |
| | Mesotrione | | | | | |
| 15 | 1.4 + | 150 + 125 | 100 | 57 | 95 | 52 |
| | Mesotrione | | | | | |

TABLE B3.3

| | | | EPPHL 7DAA | | EPPHL 30 DAA | |
|---|---|---|---|---|---|---|
| Treat- | | | | Ex- | | Ex- |
| ment | Compound | g ai/ha | Observed | pected | Observed | pected |
| 1 | 1.4 | 75 | 25 | | 18 | |
| 2 | 1.4 | 100 | 30 | | 25 | |
| 3 | 1.4 | 150 | 48 | | 25 | |
| 4 | 2.3 | 100 | 58 | | 42 | |
| 5 | Mesotrione | 75 | 30 | | 20 | |
| 6 | Mesotrione | 125 | 40 | | 35 | |
| 7 | 1.4 + 2.3 | 75 + 50 | 100 | 68 | 95 | 52 |
| 8 | 1.4 + 2.3 | 100 + 50 | 100 | 70 | 100 | 56 |
| 9 | 1.4 + 2.3 | 150 + 50 | 100 | 78 | 100 | 56 |
| 10 | 1.4 + | 75 + 75 | 93 | 48 | 95 | 34 |
| | Mesotrione | | | | | |
| 11 | 1.4 + | 100 + 75 | 98 | 51 | 93 | 40 |
| | Mesotrione | | | | | |
| 12 | 1.4 + | 150 + 75 | 98 | 63 | 88 | 40 |
| | Mesotrione | | | | | |
| 13 | 1.4 + | 75 + 125 | 100 | 55 | 100 | 46 |
| | Mesotrione | | | | | |
| 14 | 1.4 + | 100 + 125 | 100 | 58 | 93 | 51 |
| | Mesotrione | | | | | |
| 15 | 1.4 + | 150 + 125 | 100 | 69 | 100 | 51 |
| | Mesotrione | | | | | |

TABLE B3.4

| | | | BRAPL 9DAA | | BRAPL 37 DAA | |
|---|---|---|---|---|---|---|
| Treat- | | | | Ex- | | Ex- |
| ment | Compound | g ai/ha | Observed | pected | Observed | pected |
| 1 | 1.4 | 75 | 18 | | 0 | |
| 2 | 1.4 | 100 | 15 | | 0 | |
| 3 | 1.4 | 150 | 23 | | 0 | |
| 4 | 2.3 | 100 | 78 | | 37 | |
| 5 | Mesotrione | 75 | 53 | | 7 | |
| 6 | Mesotrione | 125 | 65 | | 0 | |
| 7 | 1.4 + 2.3 | 75 + 50 | 89 | 81 | 73 | 37 |
| 8 | 1.4 + 2.3 | 100 + 50 | 96 | 81 | 78 | 37 |
| 9 | 1.4 + 2.3 | 150 + 50 | 93 | 83 | 88 | 37 |
| 10 | 1.4 + | 75 + 75 | 83 | 61 | 45 | 7 |
| | Mesotrione | | | | | |
| 11 | 1.4 + | 100 + 75 | 84 | 60 | 35 | 7 |
| | Mesotrione | | | | | |
| 12 | 1.4 + | 150 + 75 | 97 | 63 | 73 | 7 |
| | Mesotrione | | | | | |
| 13 | 1.4 + | 75 + 125 | 85 | 71 | 68 | 0 |
| | Mesotrione | | | | | |
| 14 | 1.4 + | 100 + 125 | 88 | 70 | 73 | 0 |
| | Mesotrione | | | | | |
| 15 | 1.4 + | 150 + 125 | 88 | 73 | 73 | 0 |
| | Mesotrione | | | | | |

TABLE B3.5

| | | | GLXMA 9DAA | | GLXMA 37 DAA | |
|---|---|---|---|---|---|---|
| Treat- | | | | Ex- | | Ex- |
| ment | Compound | g ai/ha | Observed | pected | Observed | pected |
| 1 | 1.4 | 75 | 63 | | 45 | |
| 2 | 1.4 | 100 | 55 | | 0 | |
| 3 | 1.4 | 150 | 73 | | 30 | |
| 4 | 2.3 | 100 | 55 | | 100 | |
| 5 | Mesotrione | 75 | 45 | | 65 | |
| 6 | Mesotrione | 125 | 55 | | 88 | |
| 7 | 1.4 + 2.3 | 75 + 50 | 93 | 83 | 100 | 100 |
| 8 | 1.4 + 2.3 | 100 + 50 | 96 | 80 | 100 | 100 |
| 9 | 1.4 + 2.3 | 150 + 50 | 97 | 88 | 100 | 100 |
| 10 | 1.4 + | 75 + 75 | 97 | 79 | 100 | 81 |
| | Mesotrione | | | | | |
| 11 | 1.4 + | 100 + 75 | 95 | 75 | 100 | 65 |
| | Mesotrione | | | | | |
| 12 | 1.4 + | 150 + 75 | 96 | 85 | 100 | 76 |
| | Mesotrione | | | | | |
| 13 | 1.4 + | 75 + 125 | 95 | 83 | 100 | 93 |
| | Mesotrione | | | | | |
| 14 | 1.4 + | 100 + 125 | 96 | 80 | 100 | 88 |
| | Mesotrione | | | | | |
| 15 | 1.4 + | 150 + 125 | 96 | 88 | 100 | 91 |
| | Mesotrione | | | | | |

B3: Herbicidal Activity of a Mixture of Compound 1.4 and Mesotrione

Seeds of a variety of test species were used in drilled field trials to look at the control of important weed species present in corn crops as well as the effect on soybean (a volunteer crop in corn). Trials were carried out in Brazil in the summer season and the second season.

Plot size was 10-15 m², and two replicates were carried out per treatment. Plants were treated post-emergence between the 2 and 4 leaf stage. Species tested were Amaranthus retroflexus (AMARE), Ipomoea grandifolia (IAQGR), Digitaria horizontalis (DIGHO), Bidens pilosa (BIDPI), Eleusine indica (ELEIN), Brachiaria decumbens (BRADC), Centrus echinatus (CCHEC), Euphorbia heterophylla (EPPHL), Brachiaria plantaginea (BRAPL) and Glycine max (GLXMA; soybean). Fungicides and insecticides were used as necessary for plant health. The test was evaluated at 28 days after application with 100=total damage to plant and 0=no damage to plant.

The treatment list is shown in Table B4:

TABLE B4

| Treatment | Compound | Formulation | G ai/ha |
|---|---|---|---|
| 1 | 1.4 | EC100 | 50 |
| 2 | 1.4 | EC100 | 75 |
| 3 | 1.4 | EC100 | 100 |
| 4 | 1.4 | EC100 | 150 |
| 5 | Mesotrione | CALLISTO ® (SC480) | 75 |
| 6 | Mesotrione | CALLISTO ® (SC480) | 125 |
| 7 | 1.4 + Mesotrione | EC100 + CALLISTO ® | 50 + 75 |
| | | (SC480) | |
| 8 | 1.4 + Mesotrione | EC100 + CALLISTO ® | 75 + 75 |
| | | (SC480) | |
| 9 | 1.4 + Mesotrione | EC100 + CALLISTO ® | 100 + 75 |
| | | (SC480) | |
| 10 | 1.4 + Mesotrione | EC100 + CALLISTO ® | 150 + 75 |
| | | (SC480) | |
| 11 | 1.4 + Mesotrione | EC100 + CALLISTO ® | 50 + 125 |
| | | (SC480) | |
| 12 | 1.4 + Mesotrione | EC100 + CALLISTO ® | 75 + 125 |
| | | (SC480) | |
| 13 | 1.4 + Mesotrione | EC100 + CALLISTO ® | 100 + 125 |
| | | (SC480) | |
| 14 | 1.4 + Mesotrione | EC100 + CALLISTO ® | 150 + 125 |
| | | (SC480) | |

Observed results are shown in Tables B5.1 to 5.10 below. Expected results were calculated using the Colby Formula.

TABLE B5.1

| | | | AMARE | | AMARE | |
|---|---|---|---|---|---|---|
| | | | Summer season | | Second season | |
| Treat- | | | | Ex- | | Ex- |
| ment | Compound | g ai/ha | Observed | pected | Observed | pected |
| 1 | 1.4 | 50 | 73 | | 12 | |
| 2 | 1.4 | 75 | 80 | | 14 | |
| 3 | 1.4 | 100 | 90 | | 39 | |
| 4 | 1.4 | 150 | 100 | | 52 | |
| 5 | Mesotrione | 75 | 73 | | 40 | |
| 6 | Mesotrione | 125 | 85 | | 54 | |
| 7 | 1.4 + | 50 + 75 | 100 | 93 | 86 | 47 |
| | Mesotrione | | | | | |
| 8 | 1.4 + | 75 + 75 | 100 | 95 | 81 | 48 |
| | Mesotrione | | | | | |
| 9 | 1.4 + | 100 + 75 | 100 | 97 | 93 | 63 |
| | Mesotrione | | | | | |
| 10 | 1.4 + | 150 + 75 | 100 | 100 | 88 | 71 |
| | Mesotrione | | | | | |
| 11 | 1.4 + | 50 + 125 | 100 | 96 | 92 | 60 |
| | Mesotrione | | | | | |
| 12 | 1.4 + | 75 + 125 | 100 | 97 | 92 | 60 |
| | Mesotrione | | | | | |
| 13 | 1.4 + | 100 + 125 | 100 | 99 | 92 | 72 |
| | Mesotrione | | | | | |
| 14 | 1.4 + | 150 + 125 | 100 | 100 | 96 | 78 |
| | Mesotrione | | | | | |

TABLE B5.2

| | | | IAQGR | | IAQGR | |
|---|---|---|---|---|---|---|
| | | | Summer season | | Second season | |
| Treat- | | | | Ex- | | Ex- |
| ment | Compound | g ai/ha | Observed | pected | Observed | pected |
| 1 | 1.4 | 50 | 33 | | 0 | |
| 2 | 1.4 | 75 | 38 | | 3 | |
| 3 | 1.4 | 100 | 68 | | 36 | |
| 4 | 1.4 | 150 | 100 | | 69 | |
| 5 | Mesotrione | 75 | 63 | | 79 | |
| 6 | Mesotrione | 125 | 96 | | 87 | |
| 7 | 1.4 + | 50 + 75 | 100 | 75 | 81 | 79 |
| | Mesotrione | | | | | |
| 8 | 1.4 + | 75 + 75 | 100 | 77 | 85 | 80 |
| | Mesotrione | | | | | |
| 9 | 1.4 + | 100 + 75 | 100 | 88 | 84 | 87 |
| | Mesotrione | | | | | |
| 10 | 1.4 + | 150 + 75 | 100 | 100 | 86 | 93 |
| | Mesotrione | | | | | |
| 11 | 1.4 + | 50 + 125 | 100 | 97 | 89 | 87 |
| | Mesotrione | | | | | |
| 12 | 1.4 + | 75 + 125 | 100 | 98 | 86 | 87 |
| | Mesotrione | | | | | |
| 13 | 1.4 + | 100 + 125 | 100 | 99 | 89 | 92 |
| | Mesotrione | | | | | |
| 14 | 1.4 + | 150 + 125 | 100 | 100 | 90 | 96 |
| | Mesotrione | | | | | |

TABLE B5.3

| | | | DIGHO | | DIGHO | |
|---|---|---|---|---|---|---|
| | | | Summer season | | Second season | |
| Treat- | | | | Ex- | | Ex- |
| ment | Compound | g ai/ha | Observed | pected | Observed | pected |
| 1 | 1.4 | 50 | 23 | | 0 | |
| 2 | 1.4 | 75 | 45 | | 0 | |
| 3 | 1.4 | 100 | 45 | | 0 | |
| 4 | 1.4 | 150 | 69 | | 0 | |
| 5 | Mesotrione | 75 | 50 | | 40 | |
| 6 | Mesotrione | 125 | 72 | | 70 | |
| 7 | 1.4 + | 50 + 75 | 68 | 62 | 99 | 40 |
| | Mesotrione | | | | | |
| 8 | 1.4 + | 75 + 75 | 85 | 73 | 98 | 40 |
| | Mesotrione | | | | | |
| 9 | 1.4 + | 100 + 75 | 91 | 73 | 99 | 40 |
| | Mesotrione | | | | | |
| 10 | 1.4 + | 150 + 75 | 93 | 85 | 98 | 40 |
| | Mesotrione | | | | | |
| 11 | 1.4 + | 50 + 125 | 93 | 78 | 99 | 70 |
| | Mesotrione | | | | | |
| 12 | 1.4 + | 75 + 125 | 94 | 85 | 98 | 70 |
| | Mesotrione | | | | | |
| 13 | 1.4 + | 100 + 125 | 98 | 85 | 98 | 70 |
| | Mesotrione | | | | | |
| 14 | 1.4 + | 150 + 125 | 93 | 91 | 100 | 70 |
| | Mesotrione | | | | | |

TABLE B5.4

| | | | BIDPI | | BIDPI | |
|---|---|---|---|---|---|---|
| | | | Summer season | | Second season | |
| Treat- | | | | Ex- | | Ex- |
| ment | Compound | g ai/ha | Observed | pected | Observed | pected |
| 1 | 1.4 | 50 | 18 | | 46 | |
| 2 | 1.4 | 75 | 38 | | 46 | |
| 3 | 1.4 | 100 | 28 | | 48 | |
| 4 | 1.4 | 150 | 47 | | 60 | |
| 5 | Mesotrione | 75 | 53 | | 68 | |
| 6 | Mesotrione | 125 | 74 | | 70 | |
| 7 | 1.4 + | 50 + 75 | 83 | 61 | 80 | 83 |
| | Mesotrione | | | | | |
| 8 | 1.4 + | 75 + 75 | 87 | 71 | 88 | 83 |
| | Mesotrione | | | | | |
| 9 | 1.4 + | 100 + 75 | 88 | 66 | 89 | 83 |
| | Mesotrione | | | | | |
| 10 | 1.4 + | 150 + 75 | 93 | 75 | 86 | 87 |
| | Mesotrione | | | | | |
| 11 | 1.4 + | 50 + 125 | 96 | 79 | 83 | 84 |
| | Mesotrione | | | | | |
| 12 | 1.4 + | 75 + 125 | 79 | 84 | 95 | 84 |
| | Mesotrione | | | | | |
| 13 | 1.4 + | 100 + 125 | 93 | 81 | 95 | 84 |
| | Mesotrione | | | | | |
| 14 | 1.4 + | 150 + 125 | 99 | 86 | 96 | 88 |
| | Mesotrione | | | | | |

TABLE B5.5

| | | | ELEIN | | ELEIN | |
|---|---|---|---|---|---|---|
| | | | Summer season | | Second season | |
| Treat- | | | | Ex- | | Ex- |
| ment | Compound | g ai/ha | Observed | pected | Observed | pected |
| 1 | 1.4 | 50 | 18 | | 8 | |
| 2 | 1.4 | 75 | 25 | | 11 | |
| 3 | 1.4 | 100 | 33 | | 11 | |
| 4 | 1.4 | 150 | 53 | | 14 | |
| 5 | Mesotrione | 75 | 53 | | 20 | |
| 6 | Mesotrione | 125 | 58 | | 50 | |
| 7 | 1.4 + | 50 + 75 | 70 | 61 | 83 | 26 |
| | Mesotrione | | | | | |
| 8 | 1.4 + | 75 + 75 | 70 | 65 | 78 | 29 |
| | Mesotrione | | | | | |
| 9 | 1.4 + | 100 + 75 | 70 | 69 | 80 | 29 |
| | Mesotrione | | | | | |
| 10 | 1.4 + | 150 + 75 | 78 | 78 | 84 | 31 |
| | Mesotrione | | | | | |
| 11 | 1.4 + | 50 + 125 | 70 | 66 | 83 | 54 |
| | Mesotrione | | | | | |
| 12 | 1.4 + | 75 + 125 | 69 | 69 | 81 | 56 |
| | Mesotrione | | | | | |
| 13 | 1.4 + | 100 + 125 | 78 | 72 | 88 | 56 |
| | Mesotrione | | | | | |
| 14 | 1.4 + | 150 + 125 | 83 | 80 | 88 | 57 |
| | Mesotrione | | | | | |

TABLE B5.6

| | | | BRADC | | BRADC | |
|---|---|---|---|---|---|---|
| | | | Summer season | | Second season | |
| Treat- | | | | Ex- | | Ex- |
| ment | Compound | g ai/ha | Observed | pected | Observed | pected |
| 1 | 1.4 | 50 | 18 | | 13 | |
| 2 | 1.4 | 75 | 28 | | 21 | |
| 3 | 1.4 | 100 | 25 | | 25 | |
| 4 | 1.4 | 150 | 30 | | 43 | |
| 5 | Mesotrione | 75 | 48 | | 10 | |
| 6 | Mesotrione | 125 | 50 | | 13 | |
| 7 | 1.4 + | 50 + 75 | 58 | 57 | 65 | 22 |
| | Mesotrione | | | | | |
| 8 | 1.4 + | 75 + 75 | 75 | 63 | 73 | 29 |
| | Mesotrione | | | | | |
| 9 | 1.4 + | 100 + 75 | 77 | 61 | 78 | 33 |
| | Mesotrione | | | | | |
| 10 | 1.4 + | 150 + 75 | 73 | 64 | 78 | 49 |
| | Mesotrione | | | | | |
| 11 | 1.4 + | 50 + 125 | 65 | 59 | 65 | 24 |
| | Mesotrione | | | | | |
| 12 | 1.4 + | 75 + 125 | 80 | 64 | 73 | 31 |
| | Mesotrione | | | | | |
| 13 | 1.4 + | 100 + 125 | 78 | 63 | 83 | 35 |
| | Mesotrione | | | | | |
| 14 | 1.4 + | 150 + 125 | 78 | 65 | 85 | 50 |
| | Mesotrione | | | | | |

TABLE B5.7

| | | | CCHEC | | CCHEC | |
|---|---|---|---|---|---|---|
| | | | Summer season | | Second season | |
| Treat- | | | | Ex- | | Ex- |
| ment | Compound | g ai/ha | Observed | pected | Observed | pected |
| 1 | 1.4 | 50 | 0 | | 0 | |
| 2 | 1.4 | 75 | 0 | | 0 | |
| 3 | 1.4 | 100 | 0 | | 0 | |
| 4 | 1.4 | 150 | 0 | | 0 | |
| 5 | Mesotrione | 75 | 0 | | 0 | |
| 6 | Mesotrione | 125 | 0 | | 0 | |
| 7 | 1.4 + | 50 + 75 | 28 | 0 | 0 | 0 |
| | Mesotrione | | | | | |
| 8 | 1.4 + | 75 + 75 | 55 | 0 | 0 | 0 |
| | Mesotrione | | | | | |
| 9 | 1.4 + | 100 + 75 | 80 | 0 | 10 | 0 |
| | Mesotrione | | | | | |
| 10 | 1.4 + | 150 + 75 | 73 | 0 | 5 | 0 |
| | Mesotrione | | | | | |
| 11 | 1.4 + | 50 + 125 | 30 | 0 | 5 | 0 |
| | Mesotrione | | | | | |
| 12 | 1.4 + | 75 + 125 | 73 | 0 | 15 | 0 |
| | Mesotrione | | | | | |
| 13 | 1.4 + | 100 + 125 | 70 | 0 | 35 | 0 |
| | Mesotrione | | | | | |
| 14 | 1.4 + | 150 + 125 | 80 | 0 | 35 | 0 |
| | Mesotrione | | | | | |

TABLE B5.8

| | | | EPPHL | |
|---|---|---|---|---|
| | | | Summer season | |
| Treatment | Compound | g ai/ha | Observed | Expected |
| 1 | 1.4 | 50 | 38 | |
| 2 | 1.4 | 75 | 58 | |
| 3 | 1.4 | 100 | 46 | |
| 4 | 1.4 | 150 | 52 | |
| 5 | Mesotrione | 75 | 40 | |
| 6 | Mesotrione | 125 | 58 | |
| 7 | 1.4 + Mesotrione | 50 + 75 | 76 | 63 |
| 8 | 1.4 + Mesotrione | 75 + 75 | 89 | 75 |
| 9 | 1.4 + Mesotrione | 100 + 75 | 82 | 68 |
| 10 | 1.4 + Mesotrione | 150 + 75 | 90 | 71 |
| 11 | 1.4 + Mesotrione | 50 + 125 | 91 | 74 |
| 12 | 1.4 + Mesotrione | 75 + 125 | 77 | 82 |
| 13 | 1.4 + Mesotrione | 100 + 125 | 90 | 77 |
| 14 | 1.4 + Mesotrione | 150 + 125 | 96 | 80 |

TABLE B5.9

| | | | BRAPL | |
|---|---|---|---|---|
| | | | Summer season | |
| Treatment | Compound | g ai/ha | Observed | Expected |
| 1 | 1.4 | 50 | 13 | |
| 2 | 1.4 | 75 | 34 | |
| 3 | 1.4 | 100 | 30 | |
| 4 | 1.4 | 150 | 31 | |
| 5 | Mesotrione | 75 | 15 | |
| 6 | Mesotrione | 125 | 28 | |
| 7 | 1.4 + Mesotrione | 50 + 75 | 44 | 27 |
| 8 | 1.4 + Mesotrione | 75 + 75 | 53 | 45 |
| 9 | 1.4 + Mesotrione | 100 + 75 | 68 | 41 |
| 10 | 1.4 + Mesotrione | 150 + 75 | 70 | 42 |
| 11 | 1.4 + Mesotrione | 50 + 125 | 57 | 37 |
| 12 | 1.4 + Mesotrione | 75 + 125 | 49 | 52 |
| 13 | 1.4 + Mesotrione | 100 + 125 | 73 | 50 |
| 14 | 1.4 + Mesotrione | 150 + 125 | 79 | 50 |

TABLE B5.10

| | | | GLXMA | | GLXMA | |
|---|---|---|---|---|---|---|
| | | | Summer season | | Second season | |
| Treat- | | | | Ex- | | Ex- |
| ment | Compound | g ai/ha | Observed | pected | Observed | pected |
| 1 | 1.4 | 50 | 44 | | 44 | |
| 2 | 1.4 | 75 | 49 | | 56 | |
| 3 | 1.4 | 100 | 60 | | 79 | |
| 4 | 1.4 | 150 | 83 | | 86 | |
| 5 | Mesotrione | 75 | 69 | | 83 | |
| 6 | Mesotrione | 125 | 92 | | 89 | |
| 7 | 1.4 + | 50 + 75 | 100 | 83 | 99 | 90 |
| | Mesotrione | | | | | |
| 8 | 1.4 + | 75 + 75 | 99 | 84 | 100 | 93 |
| | Mesotrione | | | | | |
| 9 | 1.4 + | 100 + 75 | 100 | 88 | 100 | 96 |
| | Mesotrione | | | | | |
| 10 | 1.4 + | 150 + 75 | 100 | 95 | 100 | 98 |
| | Mesotrione | | | | | |
| 11 | 1.4 + | 50 + 125 | 100 | 96 | 100 | 94 |
| | Mesotrione | | | | | |
| 12 | 1.4 + | 75 + 125 | 99 | 96 | 100 | 94 |
| | Mesotrione | | | | | |
| 13 | 1.4 + | 100 + 125 | 100 | 97 | 100 | 98 |
| | Mesotrione | | | | | |
| 14 | 1.4 + | 150 + 125 | 100 | 99 | 100 | 98 |
| | Mesotrione | | | | | |

1. A method of controlling plants comprising applying to the plants, or to the locus of the plants, a composition comprising (A) a compound of formula (I) selected from the group consisting of 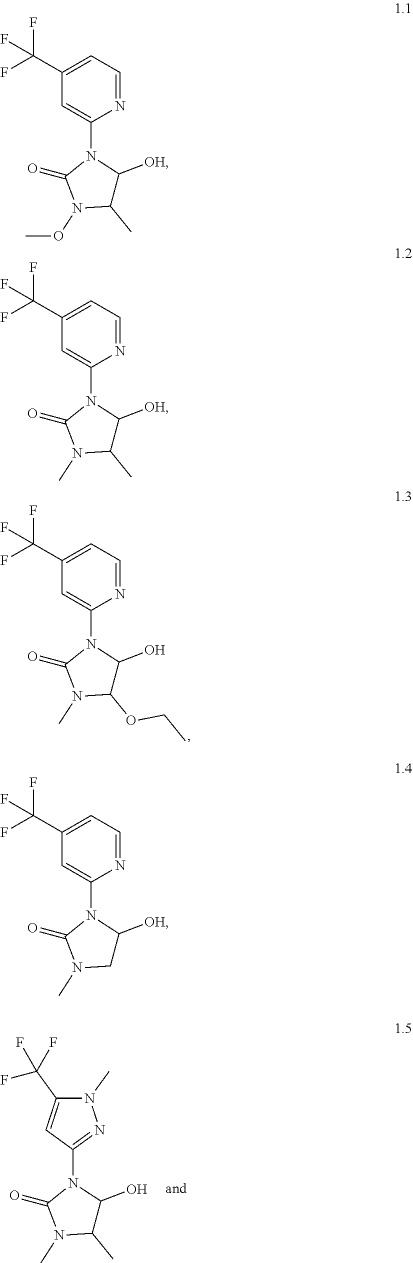 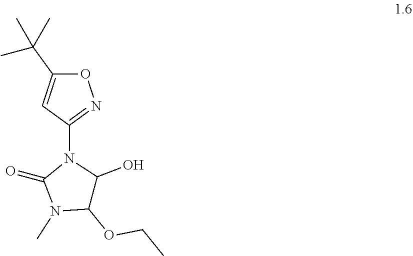 [SMILES: CCOC1C(O)N(c2cc(C(C)(C)C)on2)C(=O)N1C]
or an N-oxide or salt form thereof,
and (B) bicyclopyrone, fenquinotrione, isoxaflutole, mesotrione, pyrasulfotole, sulcotrione, tembotrione, tolpyralate, topramezone, or a compound of formula (II): 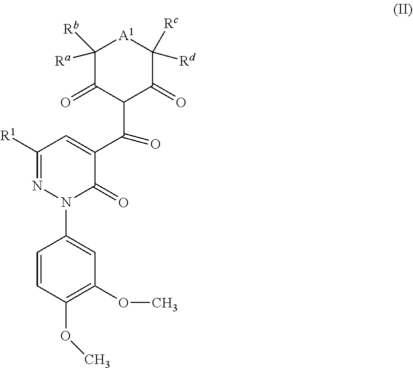
or a salt thereof,
wherein
R¹ is selected from the group consisting of hydrogen, halogen, cyano, nitro, C₁-C₆alkyl-, C₃-C₆cycloalkyl-, C₂-C₆-alkenyl-, C₂-C₆alkynyl-, C₁-C₆haloalkyl-, C₁-C₆alkoxy-, C₁-C₃haloalkoxy-, C₁-C₆alkoxy-C₁-C₃alkyl-, C₁-C₆alkyl-S(O)p- and C₁-C₆haloalkyl-S(O)p-;
A¹ is selected from the group consisting of O, C(O) and (CR^{e}R^{f});
R^{a}, R^{b}, R^{c}, R^{d}, R^{e} and R^{f} are each independently selected from the group consisting of hydrogen and C₁-C₄alkyl wherein R^{a} and R^{c} may together form a C₁-C₃alkylene chain; and
p is 0, 1 or 2,
and wherein (A) is applied at a rate of between 25 and 200 g a.i./ha and (B) is applied at a rate of between 25 and 150 g a.i./ha.

2. The method of claim 1, wherein (A) is compound 1.1.

3. The method of claim 1, wherein (A) is compound 1.2.

4. The method of claim 1, wherein (A) is compound 1.3.

5. The method of claim 1, wherein (A) is compound 1.4.

6. The method of claim 1, wherein (A) is compound 1.5.

7. The method of claim 1, wherein (A) is compound 1.6.

8. The method of claim 1, wherein (B) is bicyclopyrone, mesotrione or a compound of formula (II).

9. The method of claim 8, wherein (B) is mesotrione.

10. The method of claim 8, wherein (B) is a compound of formula (II).

11. The method of claim 1, wherein (A) is applied at a rate of 50 to 150 g a.i/ha.

12. The method of claim 1, wherein (B) is applied at a rate of 75 to 125 g a.i/ha.

13. The method of claim 1, wherein the composition is applied after emergence of the crop plant.

14. The method of claim 1, wherein the composition further includes one or more safeners selected from the group consisting of AD 67, benoxacor, cloquintocet-mexyl, cyometrinil, cyprosulfamide, dichlormid, dicyclonon, dietholate, fenchlorazole-ethyl, fenclorim, flurazole, fluxofenim, furilazole, furilazome, isoxadifen-ethyl, mefenpyr-diethyl, mephenate, oxabetrinil, naphthalic anhydride, TI-35, N-isopropyl-4-(2-methoxy-benzoylsulfamoyl)-benzamide and N-(2-methoxybenzoyl)-4-[(methylaminocarbonyl)amino]benzenesulfonamide.

15. The method of claim 14, wherein the one or more safeners are selected from the group consisint of cloquintocet-mexyl, cyprosulfamide, isoxadifen-ethyl, mefenpyr-diethyl and N-(2-methoxybenzoyl)-4-[(methylaminocarbonyl)amino]benzenesulfonamide.

16. A method of inhibiting plant growth, comprising applying to the plants or to the locus thereof, a herbicidally effective amount of a composition as defined in claim 1.

17. A method of controlling weeds in crops of useful plants, comprising applying to the weeds or to the locus of the weeds, or to the useful plants or to the locus of the useful plants, a herbicidally effective amount of a composition as defined in claim 1.

18. A method of selectively controlling grasses and/or weeds in crops of useful plants which comprises applying to the useful plants or locus thereof or to the area of cultivation a herbicidally effective amount of a composition as defined in claim 1.
